(19) United States
(12) Patent Application Publication
(10) Pub. No.: US 2024/0235945 A1
(43) Pub. Date: Jul. 11, 2024

(54) CREATING, PROVISIONING AND DEPLOYING INFRACLONES

(71) Applicant: Radhakrishna Togare, Vancouver, WA (US)

(72) Inventor: Radhakrishna Togare, Vancouver, WA (US)

(21) Appl. No.: 17/367,298

(22) Filed: Jul. 2, 2021

Related U.S. Application Data
(60) Provisional application No. 63/053,281, filed on Jul. 17, 2020.

(51) Int. Cl. H04L 41/122; H04L 67/10

(52) U.S. Cl. CPC H04L 41/122; H04L 67/10

(57) ABSTRACT

The invention disclosed in this document provides a method of deriving one or more Infraclones (virtual copies of physical infrastructure, cloud infrastructure clones or virtual clouds) from one or more standalone or interconnected physical infrastructure. Each Infraclone (aka, clone or cloud) so created will have all the characteristics of a physical cloud and can be independently operated to provide cloud services like infrastructure as a service, platform as a service, software as a service, etc., similar to those currently offered by physical cloud service providers.

Further, the invented method explained to create Infraclones reduces the time to market for an individual or a company interested in providing cloud services in the registered internet domain names, domains, sub-domains, company brand names, and/or logos of their choice as the cloud infrastructure they use is a virtual one. It also eliminates the capex and/or resources needed to build, own and/or operate the expensive, resource heavy, silo physical cloud infrastructure.

### CROSS-REFERENCE TO RELATED APPLICATION

This application claims the benefit of provisional patent application No. 63/053,281 filed Jul. 17, 2020.

### BACKGROUND

Cloud computing is a method of delivering computing and associated resources as a service over the internet. Users interested in availing cloud services request for allocation of virtual computing resources through cloud customer frontend, often a self-serving web portal, and the request is processed by the cloud management software, which handles the frontend and the backend tasks of the physical infrastructure, to dynamically provision the virtual computing resources for the end users, and to track and bill the end users for usage of virtual resources. While not limited, the services include usage of virtual compute services, virtual storage services, virtual network services, developing applications, performing computations, building services for internal or external business or individual users and so on.

Generally, the cloud computing may be grouped into public cloud, private cloud, community cloud, and hybrid cloud as follows:
Public Cloud: Also called an external cloud, public cloud is the most popular form of cloud normally run by third-party cloud service providers for use by general public and businesses. The cloud service provider dynamically allocates the virtual cloud resources opted by the users often through a self-service portal and charges the users based on the utility-billing model or pay-as-you-use basis. The general characteristics of a public cloud are ease of use, no capex, availability shared or isolated virtual resources, to users, dynamic allocation of virtual resources as needed by the users, identity based access control, better quality of service, common policies, etc.
Private Cloud: Also called an internal cloud, private cloud is an environment generally suited for private use by businesses that provide services mostly to their members. As the private cloud infrastructure is built for an organization's specific requirement, it is managed and operated by the private entity who generally builds and owns the infrastructure onsite. Entities normally own private cloud to ensure the complete governance and control on privacy and security. The general characteristics of a private cloud are dedicated infrastructure, virtual resources, custom policies, and complete control.
Community cloud: A community cloud mostly resembles a private cloud in which a group of organizations or a community uses the shared virtual computing resources of the cloud owned and operated by the community itself or hosted and operated by a third party. The community cloud is suited for companies who have shared interests and often collaborate with each other on joint projects.
Hybrid Cloud: Hybrid cloud is a model comprised of both customer owned private cloud and service provider owned public cloud computing environments. This environment helps organizations to rent and use the public cloud virtual computing resources on demand, while still maintaining their own physical onsite private cloud infrastructure, to avoid scaling the onsite infrastructure with changing business needs.
Each model explained above is further designed with one or more service layers dictated by the type and the level of service that the users like to have for their business or individual needs. The three major cloud service layers are described below:
Infrastructure-as-a-Service (IaaS): With IaaS, the cloud service provider procures and maintains the physical servers, storage, networking, and associated devices that eliminate the need for corporations to invest and manage their own systems. The end users create and use the computing and other virtual resources derived from said devices as a service.
Platform as a Service (PaaS): PaaS is a type of service that provides computing and related platform, mostly for developers, to develop products and applications. The management and maintenance of the hardware and computing resources are done by the cloud service providers.
Software as a Service (SaaS): SaaS is an application software service provided by cloud service providers to the end users. The provider installs, maintains and manages all software applications, thus eliminating the need for end users to install and manage individual applications on their computing devices.
   Limitations with Present Clouds

Developing a physical cloud infrastructure, especially Public cloud infrastructure, deploying it, and operating it to provide aforesaid cloud services can be expensive, time consuming and difficult to accomplish. Hence, currently, cloud service is provided by few cloud service providers who own their own physical (cloud) infrastructure. Individuals and companies that wish to become cloud service providers to offer services similar to those offered by said few cloud service providers are limited today for said reasons.

The invention explained here eliminates said limitations. It provides a novel method in which the whole said physical infrastructure itself is virtualized to derive as many, independent virtual copies of said physical infrastructure (i.e., virtual infrastructure, virtual cloud infrastructure, virtual infrastructure clones, virtual cloud or Infraclone) as needed. Each such Infraclone (virtual cloud) so created functions just like said physical cloud infrastructure that can be operated as a public cloud, private cloud, hybrid cloud, or community cloud to provide cloud computing services like infrastructure as a service, platform as a service, software as a service, etc., similar to those provided by physical cloud service providers today.

Said Infraclone creation method makes it possible for anyone to become a cloud service provider to offer cloud services through one or more Infraclones. Further, as compared to traditional method of building and/or operating a physical cloud infrastructure in the backend by the cloud service provider itself, the invented method disassociates the cloud service provider from the associated backend cloud infrastructure as building and/or operating the backend infrastructure is done by the Virtual Infrastructure Provider (VIP) aka Infraclone Service Provider (ICSP) who owns and operates the physical infrastructure to provide the invented Infraclone services to cloud service providers.

### BRIEF DESCRIPTION AND SUMMARY OF THE INVENTION

Cloud computing is a method of delivering computing resources over a network, generally internet. Users interested in availing cloud services request for allocation of virtual resources through cloud services frontend, often a web portal, and the request is processed by the cloud management software, which handles the frontend and backend of the infrastructure, to dynamically provision the virtual resources for the customers and track and bill the customers for usage of allocated virtual resources.

Developing a physical cloud infrastructure, deploying it, and operating it can be expensive, resource heavy, time consuming and difficult to accomplish. Hence, currently, cloud services (especially public cloud services) are provided by few companies. Individuals and companies that wish to become cloud providers are limited for said reasons.

The invented approach presented in FIG. 1 eliminates aforesaid problems. The novel method virtualizes the whole said physical (cloud) infrastructure (also called backend physical infrastructure) to create multiple virtual copies of said physical infrastructures (aka, virtual infrastructure, Infraclones, infrastructure clones, clones, or virtual clouds) from one or more standalone, co-located, or interconnected physical infrastructure, wherein each such created clone (Infraclone) may be operated as a separate cloud (public cloud, private cloud, hybrid cloud, community cloud or some combination thereof) to provide cloud services similar to that provided by other said physical cloud service providers who provide the services from their silo backend physical cloud infrastructure.

Further, the invented method disassociates the cloud service providers from said backend physical infrastructure, and instead, said backend physical infrastructure may be built and operated by one or more Virtual Infrastructure Providers (VIPs), aka Infraclone Service Providers (ICSP), who provide said Infraclone services to cloud service providers (aka virtual cloud service providers or prime users) as well as cloud computing services to customers (aka end users) attached to each Infraclone (virtual copy of said physical cloud infrastructure).

The proposed method to create multiple Infraclones consist of Infraclone Controller that is responsible for creating, deploying and managing the Infraclones for cloud service providers (prime users); and a Proxy Cloud Controller that is responsible for creating, deploying and managing the cloud computing resources for the customers (aka end users) who avail said cloud computing services through said Infraclone(s) provided by said cloud service provider(s).

The Infraclone Controller performs various operations like accepting cloud service provider's (anyone who like to provide or providing cloud services through one or more Infraclones) input through a user interface, generally a web-portal; provisioning and deploying the Infraclones, scaling of Infraclone services as needed, ensuring isolation between Infraclones and their users (cloud service providers, aka prime users), securing the Infraclones, maintaining redundancy to mitigate single-point failures, infrastructure resiliency, controlling the Infraclone access according to the service levels; setting up, monitoring, and providing various alerts related to Infraclone services; monitoring and metering of virtual resources consumed by Infraclones; billing for virtual resources consumed by the cloud service providers, and many more.

The Proxy Cloud Controller, which works as a proxy to cloud service providers, performs all functions otherwise performed by cloud service providers for their end users. The Proxy Cloud Controller functions include, but not limited to, accepting end users input through a user interface, generally a web-portal; provisioning and deploying the virtual computing resources for the end users, scaling of cloud computing resources as needed, ensuring security between end users attached to each cloud service provider, isolation between end users data, maintaining redundancy to mitigate single-point failure of cloud services and computing resources; controlling end users access according to their service levels; setting up, monitoring, and providing various alerts; monitoring and metering of virtual resources consumed by the end users of cloud services; billing of users for the usage of virtual resources, and many more.

The virtual resources required for house-keeping of the physical infrastructure, Infraclones, and end user cloud computing services are derived by virtualizing said physical infrastructure comprising of one or more compute nodes, network nodes, storage nodes, security nodes, etc. The end user virtual computing resources could include one or more, compute nodes, data nodes, network services, software applications, services for internal or external business or individual users, providing development platforms, and so on.

The method presented in this invention is unique in that it virtualizes the whole physical infrastructure itself; not just the virtual resources inside the physical infrastructure as is done by the physical cloud service providers today. This invented method creates one or more clones of physical cloud infrastructure (Infraclones or virtual copies of physical cloud infrastructure or cloud clones or cloud copies or clones) to operate each clone just like an independent physical cloud infrastructure to provide services similar to that provided by physical cloud service providers today. It further eliminates the need for individuals and companies to build, own and/or operate proprietary or silo physical infrastructure to provide cloud services, thus eliminating substantial capex, time and resources otherwise needed to provide cloud services.

### Abbreviations, Definitions, and Characteristics

For a clear explanation of disclosed invention, unless otherwise, I have coined and used the following naming conventions, definitions, abbreviations, and/or characteristics throughout this document.
1. Physical Cloud Infrastructure: Also called Physical Infrastructure throughout this document, is a non-virtualized, silo, physical infrastructure from which virtualized resources are derived for own use or to provide cloud services to others.
2. Physical cloud service provider (PCSP)
   PCSP characteristics:
      An entity that provides cloud computing services through said physical cloud infrastructure.
3. Infraclone
   Alternate names:
      Virtual copy of physical cloud infrastructure
      Clone
      Infra Clone
      Virtual Cloud Infrastructure
      Virtual Cloud Infrastructure copy
      Cloud Infrastructure copy
      Cloud clone
      Cloud (i.e. private cloud, public cloud, community cloud, hybrid cloud, or any other cloud)
      Virtual cloud (i.e. virtual private cloud, virtual public cloud, virtual community cloud, virtual hybrid cloud, or any other virtual cloud).
   Infraclone characteristics:
      Each Infraclone functions as an independent cloud (private cloud, public cloud, hybrid cloud, community cloud, etc. or some combination thereof)
      Each Infraclone functions just like a physical cloud infrastructure
      Each clone can be used to provide cloud computing services like infrastructure as a service, platform as a service, software as a service, etc. or some combination thereof.
4. Virtual Cloud Service Provider (vCSP)
   Alternate names:
      vCSP
      Prime user
      Infraclone prime user
      Infraclone owner
      Cloud owner
      Clone owner
      Virtual cloud infrastructure owner
   vCSP characteristics:
      Individual or an entity that provides or intent to provide cloud computing services through one or more Infraclones presented in this invention.
5. Cloud service provider (CSP)
   CSP characteristics:
      A general term referred to aforesaid virtual cloud service provider (vCSP) or physical cloud service provider (PCSP) who provides or intent to provide cloud computing services.
6. Prime user interface
   A portal or a web interface, also called Infra Service Portal, used for communication between Infraclone Controller and virtual cloud service provider (aka vCSP or prime user).
7. End user interface
   A portal or a web interface, also called Proxy Cloud Portal, used for communication between proxy Cloud Controller and end users (aka customers of cloud service providers) who avail cloud computing services through said Infraclone(s).
8. User Interface
   A general term referred to aforesaid prime user interface or end user interface. While for clarity, this invention explains with two separate interfaces, a prime user interface and an end user interface, it should be noted that the number of interfaces and their naming conventions do not matter. Interfaces may be added, deleted, combined or arranged in any manner to achieve the results.
9. End user (EU)
   Alternate names:
      Customer
      End customer
      Cloud computing services user
      Cloud computing services customer
      Cloud computing resources user
      Cloud computing resources customer
      User of cloud computing resources
      Customer of cloud computing resources
      Cloud user
      Proxy cloud user
      Proxy cloud end user
      Proxy cloud customer
   End user characteristics:
      Avails cloud computing resources provided as a service through one or more Infraclones operated by one or more prime users (virtual cloud service providers). Services include infrastructure services, platform services, software services, etc.
      End users include individuals, businesses, general public, etc.
10. Virtual Infrastructure Provider (VIP)
   Alternate names:
      Infraclone Service Provider
      ICSP
   VIP (ICSP) characteristics:
      Builds, owns, operates and/or maintains physical cloud infrastructure
      Uses one or more virtualization means to derive virtual resources from physical cloud infrastructure components
      Owns Infraclone Controller (explained later)
      Owns Proxy Cloud Controller (explained later)
      Through Infraclone Controller, creates, provisions and deploys Infraclones for prime users (virtual cloud service providers)
      Manages all virtual cloud service providers (i.e. Infraclone owners), their prime user interfaces (portals), and service offerings
      Through Proxy Cloud Controller, works as a proxy for prime users (virtual cloud service providers). Performs functions of prime users comprising creating, provisioning, deploying, scaling, maintaining, and/or monitoring of cloud services for Infraclone end users; provides customer support, proxy billing and account management services for Infraclone end users; and performs other functions explained in this document.
11. Infraclone Controller
   Infraclone Controller characteristics:
      Owned by Virtual Infrastructure Provider (aka Infraclone Service Provider) to provide Infraclone services to prime users (virtual cloud service providers)
      Has one or more interfaces (Infra Service Portals) to enable communication between prime user(s) and Infraclone Controller(s)
      Creates, provisions, deploys, scales and monitors virtual cloud infrastructure (Infraclones)
      Creates and manages one or more end user interfaces (Proxy Cloud Portals)
      Manages identity, access control and isolation of prime users and their Infraclones
      Performs many other functions, generally performed by silo, physical cloud service providers.
12. Proxy Cloud Controller
   Proxy Cloud Controller characteristics:
      Owned by Virtual Infrastructure Provider to provide end user cloud computing services, similar to that provided by silo, physical cloud service providers
      Creates, provisions, deploys, scales and monitors end user cloud computing resources
      Acts as a proxy for virtual cloud service providers (Infraclone owners)
      Has one or more interfaces (Proxy Cloud Portals) to communicate with end users (aka customers of cloud service providers)
      Manages identity, access control and isolation of end users (attached to each Infraclone) and their virtual computing resources
      Perform additional tasks of virtual cloud service provider, like customer support, billing and account management, etc., for end users
      Performs other functions, generally performed by silo, physical cloud service providers.

### BRIEF DESCRIPTION OF THE ATTACHED DRAWINGS

FIG. 1 shows the invented method for creating infrastructure clones (Infraclones, clones, clouds, virtual clouds or virtual copies of physical cloud infrastructure) to enable virtual cloud service providers (prime users) to provide cloud computing services to their end users (customers).

FIG. 2 shows the physical cloud infrastructure that is used to create, deploy and manage the cloud computing virtual resources for the end users.

FIG. 3 shows the invented virtual cloud infrastructure (also called Infraclones, clones) creation method wherein each Infraclone is used as an independent cloud to provide the cloud computing resources (services) for the end users.

FIG. 4 shows the sequence of Infraclone (i.e., a virtual copy of physical cloud infrastructure) creation and deployment process, and subsequent deployment of cloud computing services for the created Infraclone (cloud or virtual cloud).

FIG. 5 shows the Virtual Infrastructure Provider (VIP) aka Infraclone Service Provider (ICSP) architecture diagram having physical infrastructure that is used for creating and deploying multiple, virtual copies of physical infrastructure (virtual clouds or Infraclones) for virtual cloud service providers (prime users) to enable them provide cloud computing services to end users.

FIG. 6 shows the Infraclones creation for virtual cloud service providers (prime users, or vCSPs) using Infraclone Controller; and virtual cloud computing resources allocation for end users using Proxy Cloud Controller.

FIG. 7 shows Infraclone Controller communication with virtual cloud service providers (vCSPs) and internal common module for the creation, deployment, and management of Infraclones for virtual cloud service providers.

FIG. 8 shows enlarged view of Infra Service Portal (aka prime user interface or vCSP interface) used for communication between Infraclone Controller and virtual cloud service provider (vCSP) for Infraclone services.

FIG. 9 shows the flowchart of new Infraclone (i.e., a virtual copy of physical cloud infrastructure, or clone, or virtual cloud) creation, provisioning, deployment, and management process.

FIG. 10 shows the flowchart of deployed Infraclone (virtual cloud infrastructure) services scaling or update process.

FIG. 11 shows the flowchart of deployed Infraclone user interface (aka prime user interface generally, a self-serving web portal) customization/update and management process.

FIG. 12 shows Proxy Cloud Controller communication with Infraclone (cloud) end users and internal common module for the creation, provisioning, deployment, and management of cloud computing services for end users of Infraclone(s).

FIG. 13 shows enlarged view of Proxy Cloud Portal used for communication between Proxy Cloud Controller and end users of Infraclone (cloud) services.

FIG. 14 shows the flowchart of new end user cloud computing resources creation, provisioning, deployment, and management process.

FIG. 15 shows the flowchart of deployed end user computing resources (services) scaling or update process.

FIG. 16 shows the flowchart of proxy billing of end users (on behalf of virtual cloud service providers) for Infraclone virtual cloud computing resources consumed by the end users.

FIG. 17 shows the proxy control switch (1201) for enabling or disabling of proxy cloud control services provided by Virtual Infrastructure Provider (VIP), aka Infraclone Service Provider (ICSP), to virtual cloud service providers.

### DETAILED DESCRIPTION

Invented Infraclone Vs. Other Cloud (Aka Physical Cloud)

Before we move into the details, let us compare the physical cloud 201 deployment method (followed by others) with the disclosed Infraclones (clouds) 301 creation and deployment method.

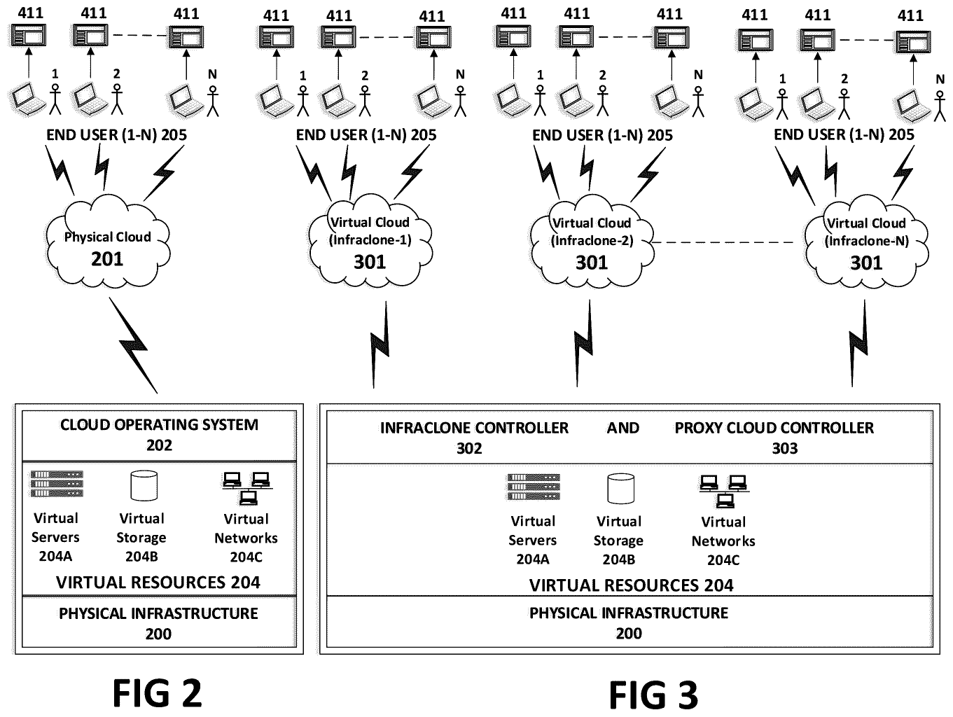

FIG. 2 shows the physical cloud 201 deployment method. The cloud operating system 202 controls the physical infrastructure 200; generally owned and/or operated by one company brand and/or its subsidiaries; to create, deploy and manage just one physical cloud 201 for end users 205 who connect from different locations over a network for the consumption of virtual computing resources 204.

FIG. 3 shows the virtual clouds (Infraclones) 301 derivation method. Unlike the cloud operating system 202 that creates just one physical cloud 201, the invented method uses Infraclone Controller 302 for virtualizing the physical infrastructure 200 to deploy multiple clouds (Infraclones) 301, and Proxy Cloud Controller 303 to deliver cloud computing virtual resources 204 through each deployed virtual cloud 301. Each Infraclone or virtual copy of the physical cloud infrastructure 301 so created functions just like a separate physical cloud 201. The derived Infraclone (virtual cloud infrastructure) 301 may be operated by an organization or individual to provide cloud services in their own brand, logo, registered domain name, domain, and/or sub-domains to end users 205 who connect to each Infraclone (cloud) 301 from different locations over a network, generally internet.

### Infraclone Creation and Cloud Services Deployment Process

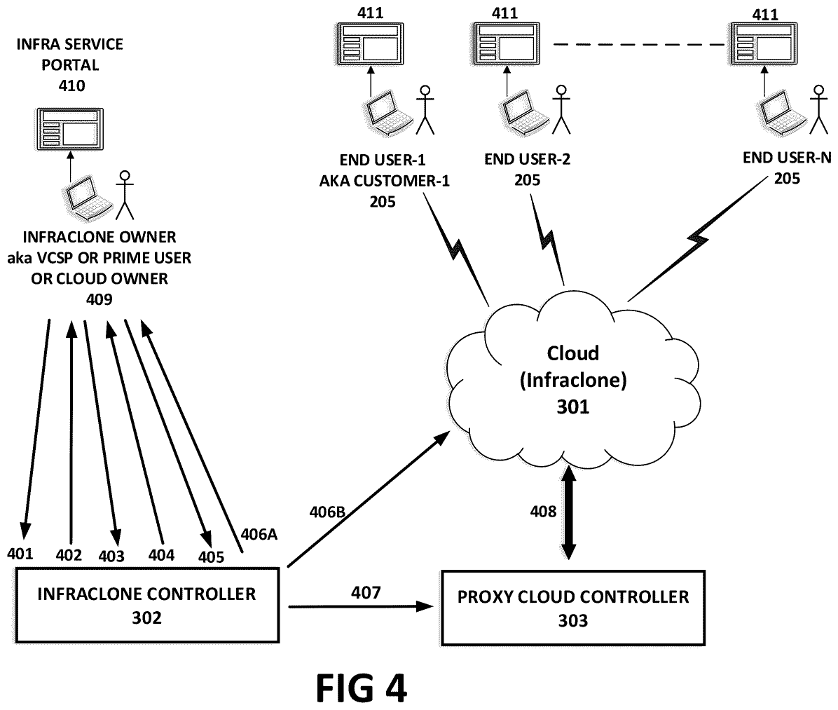

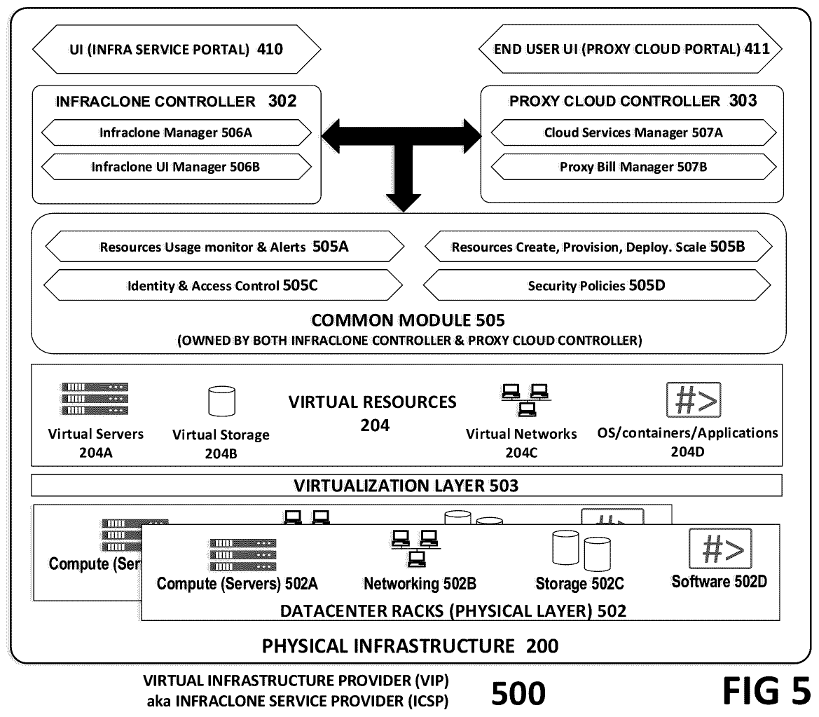

FIG. 4 shows the Infraclone (virtual cloud) 301 creation and deployment, and cloud computing services creation and deployment process. In order to understand the sequence of operation of how the Infraclone (virtual cloud infrastructure) 301 is created and deployed, and how the cloud computing services are offered through the deployed Infraclone 301, match the below numbering description to the numbering sequence shown in FIG. 4.
401. The prime user, aka vCSP (anyone who is or likes to become a virtual cloud service provider to provide cloud computing services to end users 205) 409 submits a request for an Infraclone (a copy of physical cloud infrastructure) 301 through Infra Service Portal 410, which will be received by the Infraclone Controller 302 upon vCSP 409 meeting any specific requirements or guidelines.
402. Based on the initial request received from the vCSP 409, the Infraclone Controller 302 optionally provides recommendation on the type of services that may be helpful to vCSP 409 and its end users 205.
403. The Infraclone Controller 302 receives the final selection of services from the vCSP 409 along with any Service Level Agreement and vCSP 409 specific compliance documents that may be required to enable the vCSP 409 run the cloud services.
404. The Infraclone Controller 302 verifies and confirms that the final service request submitted by the vCSP 409 is in order, approves the request; and creates, provisions and deploys the Infraclone 301 in public view disable mode, and directs vCSP 409 to customize the end user interface (generally called the Proxy Cloud Portal) 411 for its GUI appearance, logo, business information, service offers, etc. that the vCSP 409 wish to display on its end user interface 411 and/or provide to its end users 205.
405. The vCSP 409 customizes the Proxy Cloud Portal 411, does mockup run of the portal 411, and requests the Infraclone Controller 302 to approve and publish the clone 301.
406. (406A+406B): The Infraclone Controller 302 verifies and confirms that the customized interface meets Infraclone 301 publishing guidelines, informs the vCSP 409 that the Infraclone 301 is going online (406A), and publishes the Infraclone (cloud) 301 (406B).
407. The Infraclone Controller 302 directs the Proxy Cloud Controller 303 that a new Infraclone 301 has been published and to act as a proxy for the vCSP 409 to provide the cloud computing services to all end users 205 of the published Infraclone (cloud) 301.
408. Upon the direction from Infraclone Controller 302, Proxy Cloud Controller 303 will act as a proxy to vCSP 409, enable the cloud computing services that the vCSP 409 (owner of Infraclone 301) has chosen to offer to its (Infraclone) 301 end users 205, and manages the end users 205.

### VIP (Virtual Infrastructure Provider) Architecture

FIG. 5 shows the diagram of VIP (Virtual Infrastructure Provider) aka Infraclone Service Provider (ICSP) 500 architecture with physical cloud infrastructure 200 that is used for creating and deploying one or more Infraclones (virtual copies of physical infrastructure, or virtual clouds) 301 for cloud service providers 409 to enable them to provide cloud computing services to end users 205 through said Infraclone(s) 301.

The services may include infrastructure services, platform services, software services, or other computing services or a combination thereof that may be offered by the virtual cloud service providers 409. The service end users 205 (FIG. 4) include, but not limited to general public, businesses, individuals, or others involved in consuming or providing computing services like, application services, web services, mail services, e-commerce services, conferencing services, testing platforms, and so on.

The physical infrastructure 200 (FIG. 5) may be implemented with one or more standalone, interconnected, or distributed datacenters. The described layers 204, 502, 503 and blocks 302, 303, 505 can be made of software, hardware, firmware, middleware, or a combination thereof. The physical infrastructure 200, layers 204, 502, 503, illustrative blocks or modules, 302, 303, 505 and the processes described in this architecture should not be construed as a limitation. One or more layers or blocks can be added or removed or combined in any order to achieve the intended operation. Further the order of layers 204, 502, 503 and blocks 302, 303, 505 has no bearing on the VIP 500 architecture so long it produces the similar results disclosed in this invention.

The infrastructure 200 many include one or more physical hosts; generally servers consisting of one or more processors (aka compute devices) 502A, networking 502B devices, storage 502C media including hard drives, solid-state drives, flash devices, hybrid drives or tape drives; and memories including random-access memories, read-only memories, solid state memories, hybrid memories, or any other devices that may be considered as a memory device that may be used in a computing environment. Storage 502C media may be used for reading and writing of the data and to store the applications and/or data including but not limited to computer operating systems, software applications, instruction sets, codes, computer program modules, or any other items that can be considered as a digital data used in a computing environment.

The networking 502B devices include switches, bridges, routers, load balancers, security devices, and associated inter-connecting components for connecting various nodes like servers 502A, storage 502C systems, and other items used in a computing environment.

The storage 502C system may include one or more disk drives such as hard drives, flash drives, solid state drives, hybrid drives or one or more combinations thereof; and one or more interfaces between the storage 502C systems, compute 502A devices and networking 502B devices to provide interconnections to access the disk drives for reading and writing of the data. Further, the disk drive may be a part of a storage 502C array with or without RAID configuration. Additionally, the drive interfaces may include SATA, SAS, PCIe, NVMe, fiber interfaces, or any other interfaces or a combination thereof in use today or may be used in future technologies.

The software 502D may include one or more proprietary operating systems, software components, programs, modules, data structures, routines, executable codes, instructions sets or any other computer executable instructions or items or process used in a computing environment to perform and/or orchestrate the computing task(s) built for achieving the invented method; or may include existing operating systems.

The datacenter racks (physical layer) 502 comprises of aforesaid physical devices like servers 502A, networking 502B devices, storage 502C devices, etc. generally stacked inside the datacenter racks 502 made of metal, plastic, glass, porcelain, a petroleum based polymer material or a combination thereof.

Virtualization Layer 503 is used to abstract Infraclones (virtual copies of physical cloud infrastructure, or clouds) 301 for prime users (vCSPs) 409, and virtual computing resources 204 for end users 205 from the underlying physical hardware consisting of said servers 502A, networking 502B, storage 502C, and associated devices used in the cloud computing environment. One or more proprietary virtualization methods, or other virtualization methods may be used to abstract virtual resources 204 like operating systems, containers and applications 204D; virtual servers (machines) 204A; virtual storage 204B disks having logical volumes with different type of file systems and formats like GPT, NTFS, DOS, MBR, FAT, ZFS, CFS, etc.; virtual networks 204C including virtual routers, virtual load balancers, virtual switches, virtual bridges, VXLAN, VLAN, etc.; and other components like virtual desktops, virtual thin clients, virtual fat clients, etc. that can be used as virtual resources 204 required for house-keeping of physical infrastructure 200 as well as for serving prime users 409 and end users 205.

Creating, provisioning, deploying, scaling and managing of Infraclones 301 for prime users 409 (owners of Infraclones 301) is handled by Infraclone Controller 302; and creating, provisioning, deploying, scaling and managing virtual computing resources 204 for Infraclone's 301 end users 205 is handled by Proxy Cloud Controller 303, which works as a proxy to prime users (vCSPs) 409. Both Infraclone Controller 302 and Proxy Cloud Controller 303 may be made up of software, hardware, firmware, middleware or a combination thereof. The purpose of showing two modules 302, 303, each with two sub-modules 506A-B & 507A-B, is only for the explanation of the invention. The number of modules 302, 303, and sub-modules 506A-B, 507A-B and how they are arranged should not be construed as a limitation of this invention. Modules may be added, deleted, combined or arranged in any manner to provide functions explained in this invention.

Back to FIG. 4, the Infraclone Controller 302 that is responsible for managing vCSP 409 related operations may provide one or more direct or indirect user interfaces 410 to enable communication between the Infraclone Controller 302 and the vCSP 409. Frontend direct interfaces 410 may include a web interface, generally called Infra Service Portal 410, though which the vCSP 409 may communicate with Infraclone Controller 302, setup accounts, login for Infraclone 301 related services meant for vCSP (prime user) 409, check the account status, check the vCSP 409 and their end users 205 virtual resources 204 consumption status, etc. The connections between the Infraclone Controller 302 and vCSP 409 may include direct or indirect connections including but not limited to site-to-site connections, OSI layer 2 or 3 connections, VLAN, VXLAN, VPN, leased lines, etc., or a combination thereof. Further, to enable development of applications, custom end user interface 411, and additional services and communication methods; vCSPs 409 may use proprietary APIs or Infraclone Controller 302 (VIP 500) provided APIs.

Forward to FIG. 5, the Infraclones 301 for vCSPs 409 are generated with the assistance of common module 505, generally owned by Infraclone Controller 302 and Proxy Cloud Controller 303. The common module 505 may be made up of software, hardware, firmware, middleware or a combination thereof. The Infraclone Controller 302, with the assistance of common module 505; creates, provisions, deploys, scales, and maintains, the Infraclone 301 services for the prime users (aka Infraclone owners or vCSPs) 409.

The Proxy Cloud Controller 303 is a proxy to vCSP 409. The Proxy Cloud Controller 303 performs one or more functions generally carried out by vCSP 409. The Proxy Cloud Controller 303 mainly consists of Cloud Services Manager 507A and Proxy Bill Manager 507B. All communications between vCSP (prime user) 409 and end users 205 actually happen between Proxy Cloud Controller 303 and end users 205. Throughout this document, unless otherwise, all communications between vCSP 409 and end users 205 must be treated as communication between Proxy Cloud Controller 303 and end users 205. However, provision exists to allow one or more vCSPs to directly manage their end users (i.e., without the intervention of Proxy Cloud Controller) when the proxy control is disabled (explained later). The Proxy Cloud Controller 303, with the assistance of common module 505; creates, provisions, deploys, scales, and maintains, the cloud computing virtual resources 204 for the end users 205 attached to their respective prime user (vCSP) 409.

To enable communication between Proxy Cloud Controller 303 and end users 205, the Proxy Cloud Controller 303 may provide one or more direct or indirect interfaces. Frontend direct interfaces may include a web interface, generally called a Proxy Cloud Portal 411, though which the end users 205 may communicate with Proxy Cloud Controller 303, setup accounts, login for cloud computing related services, check the account status, check resource usage status, etc. The connections between the Proxy Cloud Controller 303 and end users 205 may include direct or indirect connections, including but not limited to, site-to-site connections, OSI layer 2 or 3 connections VLAN, VXLAN, VPN, leased lines, etc., or a combination thereof. Further, to enable development of applications, custom user interfaces, additional services and communication methods, end users 205 may use proprietary APIs or Proxy Cloud Controller 303 provided APIs.

The virtual computing resources 204 for end users 205 are generated with the assistance of common module 505 owned by Infraclone Controller 302 and Proxy Cloud Controller 303. The common module 505 supports Infraclone Controller 302 in creating, provisioning, deploying 505B Infraclones 301 resources for vCSPs (prime users) 409, scaling 505B and update of virtual resources 204 for Infraclone 301 service offers, monitoring 505A cloud computing virtual resources 204 being consumed by the clones 301 owners (vCSPs 409), providing alerts 505A related to the running Infraclones 301, setting up and managing identity and access control 505C for vCSPs 409 and their virtual resources 204, and managing the security policies 505D for vCSPs 409 and their virtual resources 204.

The common module 505 also supports Proxy Cloud Controller 303 in creating, provisioning, deploying 505B cloud computing virtual resources 204 for end users 205, scaling 505B and update of virtual resources 204 for the end users 205, monitoring 505A cloud computing virtual resources 204 being consumed by the end users 205, providing alerts 505A related to the running cloud services, setting up and managing identity and access control 505C for end users 205 and their virtual resources 204, and managing the security policies 505D for the end users 205 and their virtual resources 204.

### Basic Operating Principle

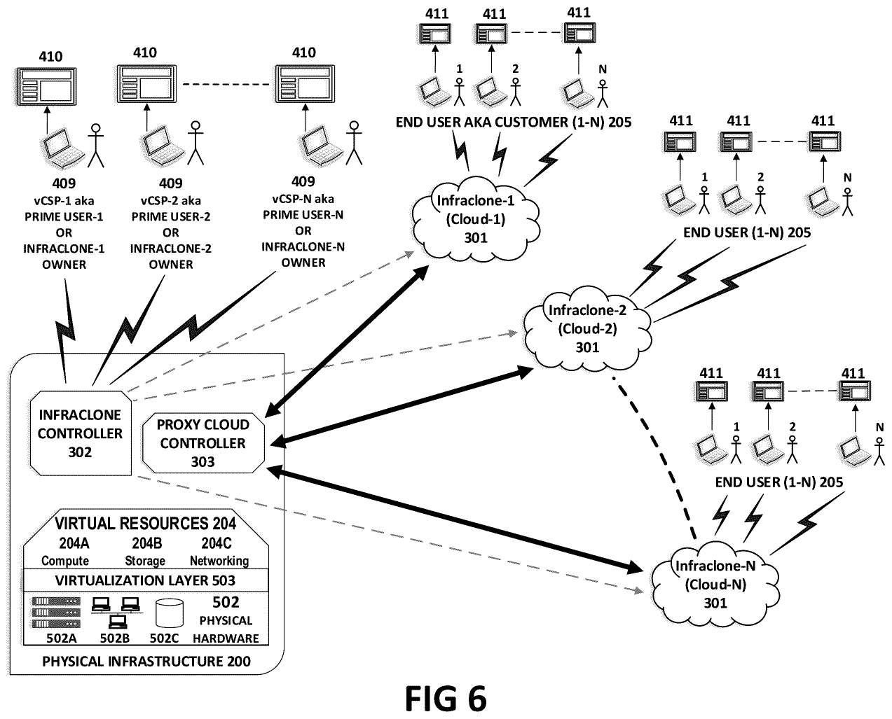

FIG. 6 shows the illustrative diagram to explain the novel method presented in this invention. The method disclosed here is on virtualization of the complete physical infrastructure 200 itself, not just the components (viz. compute, storage, network, etc.) inside a physical infrastructure 200 as done in a physical cloud 201. Hence, to accomplish the creation, deployment, scaling and maintenance of Infraclones (virtual copies of physical cloud infrastructure, also called virtual clouds) 301, and subsequent cloud computing services to be offered through each said Infraclone 301, a novel Infraclone 301 and cloud computing services creation, deployment, scaling and control method is required. The method may be implemented with software, hardware, firmware, middleware or a combination thereof.

For the purpose of explanation in this document, the control method is explained with two main control blocks, the Infraclone Controller 302 and the Proxy Cloud Controller 303. However, the number of control blocks 302, 303, and the way they are arranged is of no importance so long the functionality disclosed in this invention is achieved. Also, the invention focusses on virtual cloud infrastructure (Infraclone or clone or copy) 301 and providing cloud computing services from each said virtual cloud infrastructure 301 without specifying the type of cloud 301. However, it should be noted that the invented Infraclone 301 may be used to provide public cloud, private cloud, metro cloud, community cloud, hybrid cloud, or other types of virtual cloud services. Further, the Infraclones 301 can be delivered from a single or multiple, standalone, co-located, or interconnected physical infrastructure 200, optionally located around the world to mitigate geolocation disasters or for the advantages of serving cloud end users 205 of specific geographical locations.

The services provided through one or more clones 301 may include infrastructure services, platform services, software services, or other cloud computing services that are generally offered by a physical cloud service provider. The end users 205 include, but not limited to general public, businesses or individuals involved in consuming cloud computing resources including virtual compute 204A resources, virtual network 204C resources, virtual storage 204B resources, application resources 204D, software development services, e-commerce services, testing platforms, etc.

The Infraclone Controller 302 module is responsible for the creation and management of Infraclones (virtual cloud infrastructure or virtual cloud) 301. The clones 301 are isolated from one another in a secured manner to enable each of the clones 301 act as an independent cloud 301 to provide cloud services to end users 205.

The Infraclone Controller 302 may provide one or more user interfaces 410, generally referred to as Infra Service Portal 410, to provide the required Infraclone 301 services to virtual cloud service providers (aka prime users or cloud owners or vCSPs) 409. However, the communication interface 410 may include, but not limited to, any web-portals, custom user interfaces, site-to-site connections, remote access network connections; OSI layer 2 or layer 3 connections including VLAN, VXLAN, VPN; leased lines, etc. or a combination thereof. Such interface 410 may be used to accept the necessary input details from the vCSP 409 for the creation, deployment, and maintenance of clone 301 services, and Infraclone 301 end user interface (also called Proxy Cloud Portal) 411 services through which the cloud services are administered for end users 205.

The Proxy Cloud Controller 303 module is responsible for managing the end users 205 as a proxy to vCSPs (prime users) 409. All communications between vCSP 409 and end users 205 actually take place between Proxy Cloud Controller 303 and end users 205. Throughout this document, unless otherwise, all communications between vCSP 409 and end users 205 must be treated as communication between Proxy Cloud Controller 303 and end users 205. However, provision exists to allow one or more vCSPs to directly manage (i.e., without the intervention of Proxy Cloud Controller) their end users when the proxy control is disabled (explained later).

While the Infraclone Controller 302 generally manages clone 301 creation, deployment, and clone's frontend (UI) 411 tasks for vCSP 409 to enable vCSP 409 provide service offers and UI 411 of their choice for end users 205; it is the Proxy Cloud Controller 303 that provides the actual cloud computing services for the end users 205. In addition, Proxy Cloud Controller 303 provides proxy billing (Proxy Bill Manager 507B), account management and customer support for end users 205, receives payments for vCSPs 409, and performs other functions generally performed by physical cloud providers 409 and/or their third parties.

The Infraclone Controller 302 creates and deploys one or more virtual cloud infrastructure 301 for vCSPs 409 by virtualizing the physical infrastructure resources 200. It also provisions and deploys 505B the virtual resources 204 for the Infraclones 301, scales the clones 301 as needed, monitors the clones 301, and provides necessary alerts 505A and any other services for the clones 301 while ensuring the identity, access control 505C and security polices 505D set for each clone 301 and vCSP 409 (clone 301 owner).

The Proxy Cloud Controller 303 provisions and deploys 505B the cloud computing virtual resources 204 for the end users 205 attached to each clone by virtualizing the physical infrastructure 200 hardware resources 502. The Proxy Cloud Controller 303 also scales and monitors 505B the virtual resources 204, provides necessary alerts 505A and any other services for the end users 205 while ensuring the identity and access control 505C, and security polices 505D set for the virtual resources 204 and the end users 205.

The end user 205 cloud services provided by Proxy Cloud Controller 303 may include, but not limited to, infrastructure services, platform services, software services, or any other services that may include computing operations involving end user's 205 local network and virtual resources 204; providing online services like data, voice and video, VOIP or any messaging services; computing operations; e-commerce platforms, web services, virtual private networks for communication between end user's 205 local networks and clone 301 networks, and so on. APIs are provided to the end users 205 to enable them develop and/or integrate custom applications and services for their internal and external consumptions, create end user 205 customer experience, and/or develop additions services required for direct and indirect site-to-site communications, etc.

The virtual resources 204 required for the provisioning and deployment 505B of virtual cloud infrastructure (Infraclone) 301 for the vCSP 409, and the cloud computing virtual resources 204 used by the end users 205, are generated by virtualizing the physical infrastructure 200 hardware resources 502 consisting of one or more compute 502A, networking 502B, storage 502C, and other associated components.

### Detailed Operating Principle

The present invention to create multiple virtual copies of physical infrastructure (aka Infraclones, virtual cloud, or virtual cloud infrastructure) 301 will be explained in detail with some preferred embodiments. It must be understood that although the invention disclosed provides a detailed description of a method to create generalized virtual infrastructure copies from one or more standalone or interconnected physical infrastructure 200, it is not limited to any one specific type of cloud computing environment. The same method may be applied to derive one or more Infraclones (public cloud, private cloud, hybrid cloud, community cloud, or any other cloud) 301 from a new physical infrastructure 200; or by modifying, converting or upgrading existing physical infrastructure 200, or a combination thereof. The method provided in this invention is not constrained so long the method results in creation of one more Infraclones or virtual copies of physical infrastructure 301 to provide cloud services. The details provided here is mainly to convey the information for those skilled in the art. Suitable changes, alterations, additions, deletions and substitutions to the method may be made without departing from the fundamental theme of the disclosed invention.

The invented method to create and deploy Infraclones 301 may be best explained by separating the Infraclone 301 creation, deployment and management process; and cloud computing virtual resources 204 (provided through each clone 301) creation, deployment and management process. For clarity and ease of explanation, several block diagrams and flow charts, each having some function(s), are shown. However, it should be understood that the number of blocks used in the block diagrams or flowcharts, and the way the blocks are connected or arranged in the block diagrams or flowcharts should not be construed as a limitation. The block(s) in the block diagrams and flow chart(s) can be added, deleted, combined, or arranged in any manner to achieve the desired results explained in this invention without deviating from the theme of the invention.

### Infraclone Controller Operation

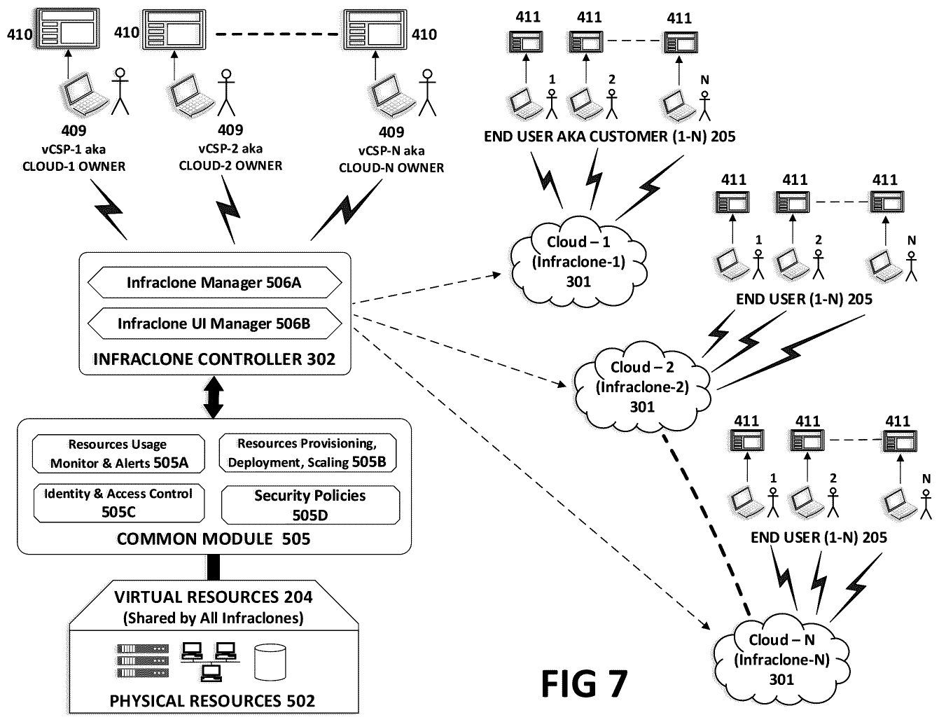

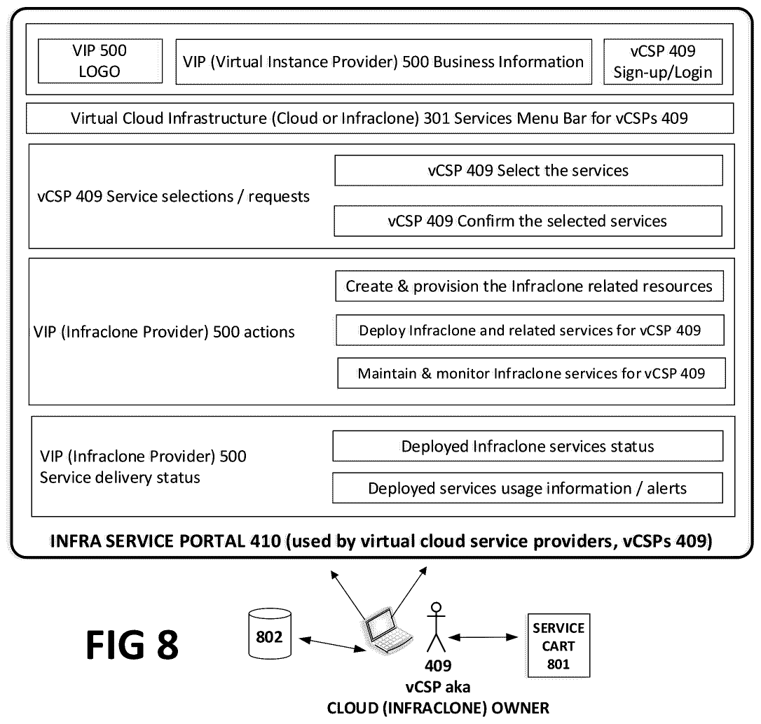

FIG. 7 shows Infraclone Controller 302 communication diagram. For the purpose of explanation, the Infraclone Controller 302 is shown with two sub-modules, the Infraclone Manager 506A and Infraclone UI Manager (aka Clone UI Manager) 506B. Infra Service Portal 410, shown separately for vCSP 409 for the purpose of explanation, accepts the prime users (vCSP) 409 service requests. A vCSP 409 can avail one or more clones 301 or a single clone 301 may be shared by many vCSPs 409. While for the purpose of explanation, a web-portal 410 is shown as the direct communication interface 410 between vCSP 409 and Infraclone Controller 302, the communication interface 410 may be made up of one or more interfaces 410 including but not limited to site-to-site connections, remote access network connections; OSI layer 2 or layer 3 connections including VLAN, VXLAN, VPN; leased lines, etc. or a combination thereof.

The Infraclone 301 services offered by Infraclone Controller 302 also include services that can be used by the vCSPs 409 to provide cloud computing services to end users 205; scaling, upgrade and downgrade of clone 301 services offered by each vCSP 409 to end users 205; clone 301 UI (web-portal used by end users 205 to avail cloud computing services) 411 or other interface 411 scaling and update services, and so on. The vCSPs 409 request the services from the Infra Service Portal 410 and once confirmed by the vCSP 409, the Infraclone Controller 302 module processes and completes the requested task. The common module 505 assists Infraclone Controller 302 to accomplish one or more tasks or a combination of tasks directed by the Infraclone Controller 302 including provisioning, deployment 505B of clones 301 and scaling 505B of clone 301 service offers for end users 205 using custom or pre-defined template or without a template or by other means. The common module 505 also assists the Infraclone Controller 302 in monitoring 505A of clone 301 virtual resources 204 and providing alerts 505A to vCSP 409 related to their clone(s) 301 performance, managing the security polices 505D for vCSP 409 and their clone(s) 301, and managing the identity and access control 505C for vCSPs 409 and their clones 301.

The Infraclone Controller 302 receives the service request from vCSP 409 through Infra Service Portal 410. The portal 410 may include a services request or update or scaling wizard that will walk through the vCSP 409 with default settings or targeted options to suit vCSP 409 and/or end users 205 requirements. The services selected through the wizard may include creation of new clone 301, scaling of clone 301, deletion of clone 301, and so on. Once the selections are made, the vCSP 409 will validate the selection and submits the request to the Infraclone Controller 302 through the Infra Service Portal (generally a web-portal) 410. The service input method may also involve clicking various buttons on the Infra Service Portal 410, selecting item(s) from one or more dropdown boxes, or providing inputs through one or more wizards, or any method used for requesting remote internet services, or a combination thereof. The Infra Service Portal 410 may provide access to open multiple windows or links to use the services.

The Infra Service Portal 410, expanded and shown in FIG. 8, may provide for vCSP 409, account signup and login options, demo video links on the services offered, help and documentation on Infraclone 301 services and offers, configuration and submittal of service requests for deployment of clones 301 and services or scaling of deployed services, SLA management of clone 301 services, various recommendations both static and dynamic according to vCSP 409 applicable services, a dashboard of services available and used by vCSPs 409 and its end users 205, real-time updates, graphs of services consumed; APIs for building services for deployment, monitoring, scaling, predictions, automation, capacity analysis, policy, and security services; template services, user targeted recommendations, an e-commerce shopping cart 801 for placing the selected clone 301 services for checkout and submission of selected services, options to update or delete the information stored in the cart 801 or cancel the selected services before checking out; monitoring or alert windows to draw vCSP 409 attention, and many more. The portal may also include a browser cache 802 or a datastore 802 for storing the data of unsigned users 409 or for temporary use that can be used for portal 410 configuration management, portal 410 services, namespace management, and/or other items, or other storage 204B media for storing the initial inputs that users 409 key-in before making a final click on the type of service that the user likes to avail. Options may also be available for the vCSP 409 to create clone 301 service offer template(s) that may be used for different themes, occasions or seasonal promotional offers, changing services, etc. for use by vCSP 409 itself or presenting it to the end users 205.

Infraclone Controller 302 (FIG. 7), upon receiving a service request from vCSP 409, checks whether it is Infraclone 301 related services request or, end users 205 UI 411 related services request for the existing clone 301. Depending on the type of request, the Infraclone Controller 302 transfers the control to the Infraclone Manager 506A or Infraclone UI Manager 506B. While for the purpose of clarity the Infraclone Controller 302 is shown with only two sub modules (blocks) 506A-B, one for clone 301 services, and the other for UI 411 services for the clone 301 already created or used by the vCSP 409; number of blocks 506A-B, their functionality, and the way they are arranged do not matter. Blocks may be added, deleted, combined or arranged in any manner to achieve the results.

The Infraclone Manager 506A, a module of Infraclone Controller 302, is responsible for creation and deployment 505B of Infraclones 301 and service offers, and/or scaling 505B of clone 301 services offered by vCSPs 409 for their end users 205. The Infraclone Manager 506A, analyzes the Infraclone 301 service request to verify if it is a new clone 301 creation request, or a service scaling or update request for an existing clone 301. If the request is for the new clone 301 creation and the prime user (vCSP) 409 is signing up for the first time, then the clone 301 manager provides the details of the services available, business requirements, SLA, payment, recommendations and other items for the vCSP 409 to verify and confirm, and Infraclone Manager 506A receives the finalized clone 301 service request from the vCSP 409. Upon verifying and approving the SLA and the services requested by the vCSP 409 for the new clone 301 creation, the Infraclone Manager 506A creates and provisions the clone 301 either from the available templates or from a newly created template or without the need of a template, and deploys the clone 301 in a public view disable mode so that the vCSP 409 could customize the clone 301 before enabling it to provide the Infraclone (cloud) services for the end users 205. The vCSP 409, upon receipt of the clone 301 deployment by the Infraclone Controller 302, customizes the end user's 205 Proxy Cloud Portal (UI) 411 with logo, business information, services offerings, etc. of the vCSP 409, and requests the Infraclone Manager 506A to activate the clone 301. The Infraclone Manager 506A, after verifying and confirming that the customized clone 301 meets Infraclone 301 publishing guidelines, activates the clone 301 and the clone 301 goes live and becomes a (virtual) cloud 301 with a user interface frontend (Proxy Cloud Portal) 411, which is managed by Proxy Cloud Controller 303 for vCSP 409, for providing the cloud computing services to end users 205. While the end user 205 frontend 411 customization including service offers is handled by vCSP 409 or Infraclone Controller 302; creating, provisioning, deployment, scaling and management of cloud computing services (virtual resources 204) for end users 205 are handled by Proxy Cloud Controller 303.

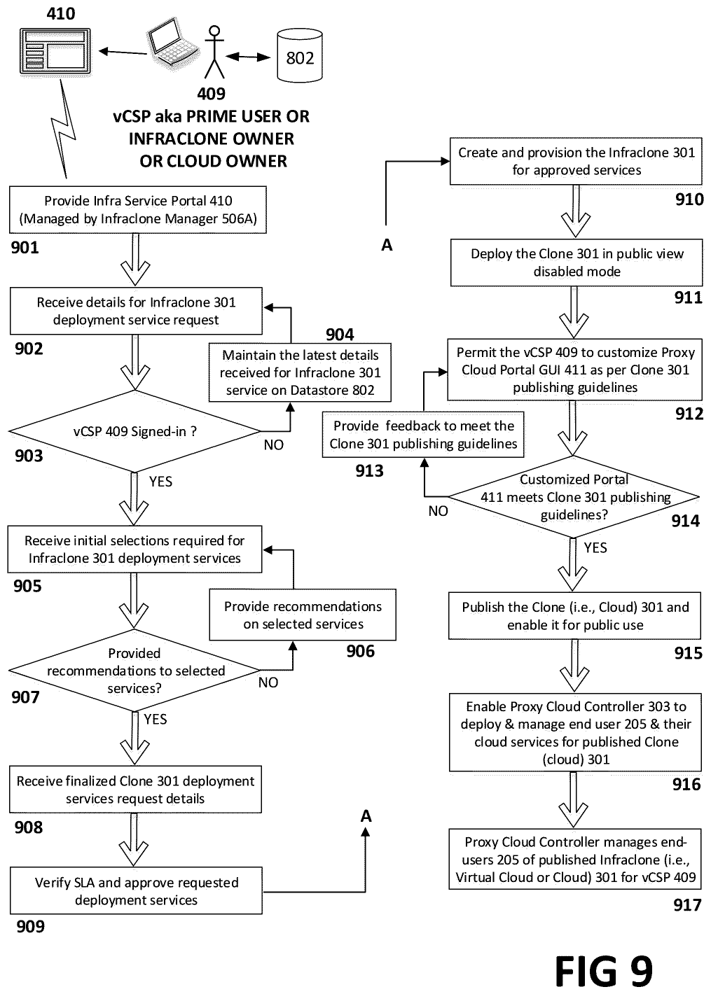

The process of Infraclone 301 creation can be best explained with the help of a flowchart shown in FIG. 9. The Infra Service Portal 410 provided by Infraclone Manager 506A is used for communication between vCSP 409 and Infraclone Manager 506A. Consider a vCSP 409 (i.e., a business or an individual already providing or intent to provide cloud computing services) likes to provide Infraclone (i.e., cloud) 301 services to end users 205, but has not setup any account with the Virtual Infrastructure Provider (VIP) 500, visits the portal 410 and checks the services (BOX 901) available for the vCSP 409 to provide the cloud computing to end users 205. As an unsigned prime user 409 (BOX 903) of the portal 410, the vCSP 409 might be interested in knowing the services, running the demo(s) or other things to understand how the clone 301 services work rather than actually signing up for the service that the vCSP 409 is not familiar with or unheard of. The vCSP 409 might decide to proceed with the selection of service components for availing the clone 301 services and as the vCSP 409 is not yet signed in (BOX 903), the details the vCSP 409 provide for the requested services (BOX 902) may be stored in a datastore/cache 802 (BOX 904). When the vCSP 409 signup or sign-in (BOX 903), the Infraclone Manager 506A checks the vCSPs 409 datastore 802 (BOX 904) and loads in the information and the datastore 802 (BOX 904) gets updated as and when the vCSP 409 adds or updates the details for the requested services in the datastore/cache 802 (BOX 904). When the initial selection of the services by the vCSP 409 is complete and submitted along with the vCSP 409 specific SLA, business compliance, and any other details (BOX 905), the Infraclone Manager 506A verifies the selected services and provides recommendations to selected Infraclone 301 services (BOX 906-907) that may be applicable for the vCSP 409 and its targeted end users 205 along with any additional requirements to meet the vCSP 409 compliance and SLA and other requirements. Upon going through the recommendations (BOX 906-907) and with any changes made to vCSP 409 request details, the vCSP 409 submits the final request (BOX 908) along with any additional details required for availing the Infraclone 301 services. The Infraclone Manager 506A verifies that the services request, compliance, SLA and other details provided by the vCSP 409 are in order (BOX 909), and creates and provisions the clone 301 for the approved services (BOX 910) and deploys (BOX 911) the clone 301 with the assistance of common module 505 owned by both Infraclone Controller 302 and Proxy Cloud Controller 303. To help vCSP 409 customize the Infraclone's 301 UI (Proxy Cloud Portal) 411, which will be managed by Proxy Cloud Controller 303 once the clone 301 is published, the Infraclone Manager 506A deploys the clone 301 in public view disable mode (BOX 911), and permits vCSP 409 to customize the clone 301 user interface (Proxy Cloud Portal) 411 with any recommendations (BOX 913) and updates to logo, business information, service offers, etc. (BOX 912) of the vCSP 409 to be seen by end users 205 visiting Proxy Cloud Portal 411. The vCSPs 409 may also bring in their own end-user UI 411 frontend, or use the available APIs to build custom interfaces 411 for direct or indirect frontend or backend connections of their choice. Once the interface portal 411 is ready for publishing (BOX 914), the vCSP 409 requests the Infraclone Manager 506A to publish the portal 411. After verifying and approving clone 301 that meets clone 301 publishing guidelines (BOX 914), the Infraclone Manager 506A publishes the clone 301 (BOX 915), informs the vCSP 409 that the clone 301 is published, and enables the Proxy Cloud Controller 303 to deploy and manage end user 205 cloud computing services (BOX 916) through Proxy Cloud Portal 411 of the published clone 301, which is now a virtual cloud 301, or simply referred to as, cloud 301. While Infraclone Controller 302 continues to maintain all clone 301 related services, the Proxy Cloud Controller 303 will deploy and manage all end user 205 related cloud computing services for the published clone 301 (BOX 917).

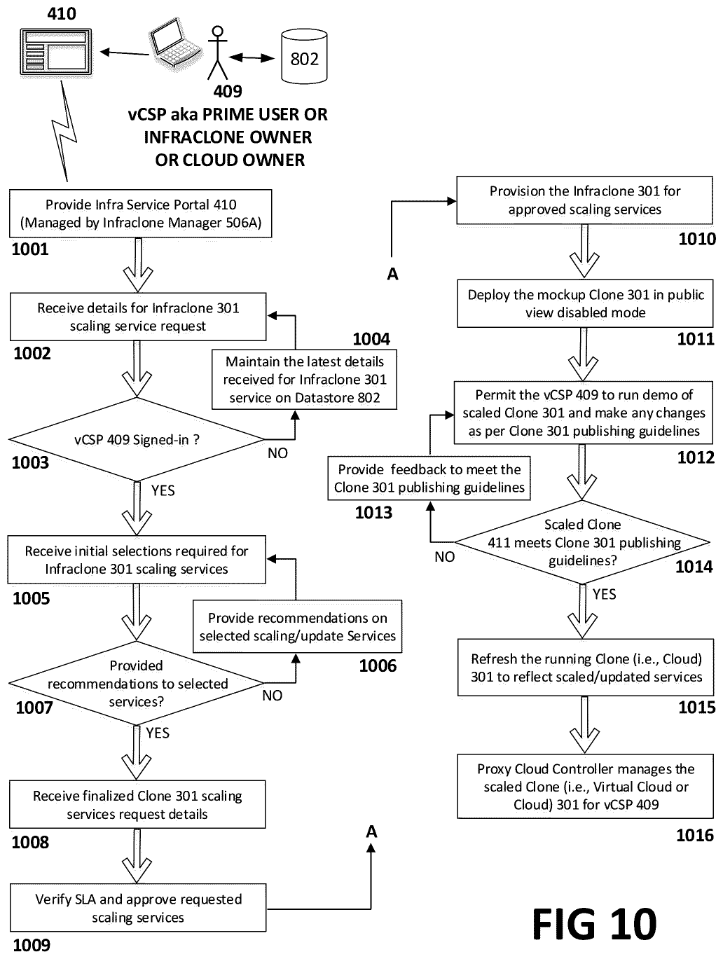

As and when needed, the vCSP 409 may offer additional services, scale up or down the existing services, or discontinue some services for their end users 205. The Infraclone Manager 506A; in addition to creating, provisioning, deploying, and maintaining the services; performs these functions. The Infraclone 301 services scaling, upgrade or downgrade process may be best explained with the help of a flowchart shown in FIG. 10. Consider a vCSP 409 offering cloud services through one or more Infraclones 301 intend to offer new or additional services, scale the services, or likes to remove the services from existing offers for its end users 205; or perform any other tasks that might need the Infraclone Manager's 506A support. The vCSP 409 might visit the Infra Service Portal 410 unsigned or signed. An unsigned vCSP 409 may visit the portal 410 and check the additional or scaling services (BOX 1001) available for the vCSP 409 to provide to its cloud computing end users 205. As an unsigned user 409 (BOX 1003) of the Infra Service Portal 410, the vCSP 409 might be interested in knowing new service offers or understanding how to scale, upgrade, downgrade, or remove the services from the current offers; running the demo(s) or other things to understand how the new offers creation, scaling and/or updates services might work without publishing the updated services; and so on. The vCSP 409 might decide to proceed with the selection of service components for availing the services and as the vCSP 409 is not yet signed in (BOX 1003), the details the vCSP 409 provides for the requested services (BOX 1002) may be stored in a datastore/cache 802 (BOX 1004). When the vCSP 409 sign-in (BOX 1003), the Infraclone Manager 506A checks the vCSP's 409 datastore 802 (BOX 1004) and loads in the information and the datastore 802 (BOX 1004) gets updated as and when the vCSP 409 adds or updates the details for the requested services in the datastore/cache 802 (BOX 1004). When the initial selection of the services by the vCSP 409 is complete and submitted along with the vCSP 409 specific SLA, business compliance, and any other details (BOX 1005), the Infraclone Manager 506A verifies the selected services and provides recommendations to selected services (BOX 1006-1007) that may be applicable for the vCSP 409 and its targeted end users 205 along with any additional requirements to meet the vCSP 409 compliance and SLA and other requirements. Upon going through the recommendations (BOX 1006-1007) and with any changes made to vCSP 409 request details, the vCSP 409 submits the final request (BOX 1008) along with any additional details required for availing the Infraclone 301 services. The Infraclone Manager 506A verifies that the services request, the compliance, SLA and other details provided by the vCSP 409 are in order (BOX 1009), and provisions (BOX 1010) the clone 301 for the approved services and deploys (BOX 1011) the additional, scaled or updated clone 301 services with the assistance of the common module 505 owned by both Infraclone Controller 302 and Proxy Cloud Controller 303. To ensure the new services to be deployed is as per the service request, the Infraclone Manager 506A deploys a mockup demo clone 301 with new services in a public view disable mode (BOX 1011), and permits vCSP 409 to verify and make any additional changes to the mock-up clone 301 with any recommendations (BOX 1013), if needed (BOX 1012). Once the clone 301's new offers are accepted and confirmed by the vCSP 409 (BOX 1014), the vCSP 409 request the Infraclone Manager 506A to publish the clone 301. After verifying and approving the clone 301 that meets publishing guidelines (BOX 1014), the Infraclone Manager 506A publishes the updated clone 301 with a refresh to the Proxy Cloud Portal 411 (BOX 1015). Previous clone 301 may be retired, archived, or templated, as the case may be. The Infraclone Controller 302 continues to maintain all clone 301 related services while the Proxy Cloud Controller 303 will continue to maintain all the end user 205 related services provided by the scaled/updated clone 301 (BOX 1016).

The Infraclone UI Manager 506B is another module within the Infraclone Controller 302 (FIG. 7). While the Infraclone Manager 506A is responsible for creating and deploying the clones 301 and the services through clone's 301 end user interface (Proxy Cloud Portal) 411, the actual management of end user interfaces 411 is done by the Infraclone UI Manager 506B. Further, generally, the vCSP 409 is responsible for deciding the services and customizing the frontend interface (Proxy Cloud Portal) 411 the way the vCSP 409 want it appear to the end users 205. To achieve this, the Infraclone Controller 302 provides various templates, options, portal themes, UI libraries, etc. to vCSPs 409 to bring them up to speed when they first sign-in for the clone 301 services or when they like to update the clone's 301 end user 205 frontend 411 as needed. Further, vCSP 409 may use or provide other direct or indirect interfaces 411 involving site-to-site connections, remote access network connections; OSI layer 2 or layer 3 connections including VLAN, VXLAN, VPN; leased lines, etc. or a combination thereof, or bring in their own interface frontend 411, or customize the UI 411 and the services to be presented through vCSP's 409 Proxy Cloud Portal 411 with VIP 500 or third-party provided Proxy Cloud Portal 411 customization APIs.

The Infraclone UI Manager 506B, upon receiving the end user's 205 UI 411 change or update service request for an existing clone 301 from a signed-in prime user (vCSP) 409, provides the details of the end user 205 UI 411 update services available, business compliance, SLA, payment, recommendations, and other items for the vCSP 409 to verify and confirm, and the Infraclone UI Manager 506B checks the finalized UI 411 change request received from the vCSP 409. Upon verifying and approving the vCSP 409 compliance, SLA and the services requested by the vCSP 409 for the UI 411 change or update, the Infraclone UI Manager 506B updates and provisions the clone 301 either from the available templates or from a newly created template or without the need of a template, and deploys a mock-up copy of the UI (Proxy Cloud Portal) 411 in a public view disable mode so that the vCSP 409 could verify and confirm that the UI 411 to be deployed for the end users 205 is as per the service request. The vCSP 409; upon receipt of the mock-up UI 411 deployment by the Infraclone UI Manager 506B, verifies the mock-up UI (Proxy Cloud Portal) 411 details like logo, business information, services offerings, etc. of the vCSP 409 and on confirming that the mock-up meets the vCSP 409 UI 411 update service request with any changes to UI 411 as needed; requests the Infraclone UI Manager 506B to updated the portal 411 with new UI 411. After verifying and approving clone 301 that meets publishing guidelines, the Infraclone UI Manager 506B publishes the updated Proxy Cloud Portal 411 with a refresh to clone 301. The Proxy Cloud Controller 303, without any disruption during the UI 411 update process continues to manage end users 205 of vCSP 409; and also provisions, deploys, scales and manages cloud computing services (virtual resources 204) for end users 205.

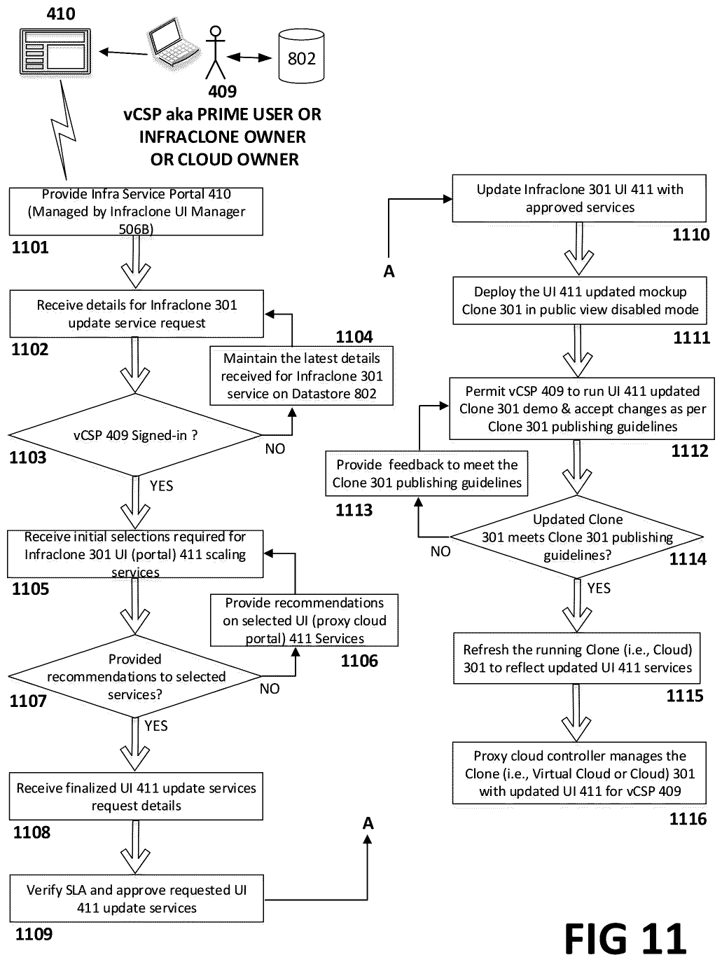

The clone 301 end user 205 UI 411 update process can be best explained with the help of a flowchart shown in FIG. 11. The Infra Service Portal 410 shown in the diagram is used for communication between vCSP 409 and Infraclone UI Manager 506B. Consider a vCSP 409 likes to avail clone 301 UI 411 update services, but has not signed-in, visits the Infra Service Portal 410 and checks the UI 411 services (BOX 1101) available for the vCSP 409 to provide to their cloud computing end users 205. As an unsigned prime user (vCSP) 409 (BOX 1103) of the Infra Service Portal 410, the vCSP 409 might be interested in knowing the UI 411 services, running the demo(s) or other things to understand how the clone 301 UI 411 services work rather than actually availing the services that the vCSP 409 is not familiar with or unheard of. The vCSP 409 might decide to proceed with the selection of service components for availing the clone 301 UI 411 services and as the vCSP 409 is not yet signed in (BOX 1103), the details the vCSP 409 provide for the requested services (BOX 1102) may be stored in a datastore/cache 802 (BOX 1104). When the vCSP 409 sign-in (BOX 1103), the Infraclone UI Manager 506B checks the vCSPs 409 datastore 802 (BOX 1104) and loads in the information and the datastore 802 (BOX 1104) gets updated as and when the vCSP 409 adds or updates the details for the requested services in the datastore/cache 802 (BOX 1104). When the initial selection of the UI 411 services by the vCSP 409 is complete and submitted along with the vCSP 409 specific SLA, business compliance, and any other details (BOX 1105), the Infraclone UI Manager 506B verifies the selected services and provides recommendation to selected services (BOX 1106-1107) that may be applicable for the vCSP 409 and its targeted end users 205 along with any additional requirements to meet the vCSP 409 compliance, SLA and other requirements. Upon going through the recommendations (BOX 1106-1107) and with any changes made to vCSP 409 request details, the vCSP 409 submits the final request (BOX 1008) along with any additional details required for availing the clone 301 UI 411 services. The Infraclone UI Manager 506B verifies that the services request, the compliance, SLA and other details provided by the vCSP 409 are in order (BOX 1009), and updates the Infraclone 301 UI 411 for the approved services (BOX 1110) and deploys (BOX 1111) the clone 301 with the assistance of common module 505 owned by both Infraclone Controller 302 and Proxy Cloud Controller 303 in public view disable mode (BOX 1111), and permits vCSP 409 to verify and make any additional updates with any recommendations (BOX 1113), if required, for logo, business information, service offers, etc. (BOX 1112) of the vCSP 409 to be seen by end users 205. Once the interface portal 411 frontend is ready for live update (BOX 1114), the vCSP 409 requests the Infraclone UI Manager 506B to update the portal 411. After verifying and confirming that the changes requested by the vCSP 409 meets the clone 301 UI publishing guidelines (BOX 1114), the Infraclone UI Manager 506B approves the request and publishes (BOX 1115) the new UI 411 with a refresh to clone 301, while Proxy Cloud Controller 303 continues to maintain all vCSP 409 end users 205 and their cloud computing services for the attached clone 301 (BOX 1116).

### Proxy Cloud Controller Operation

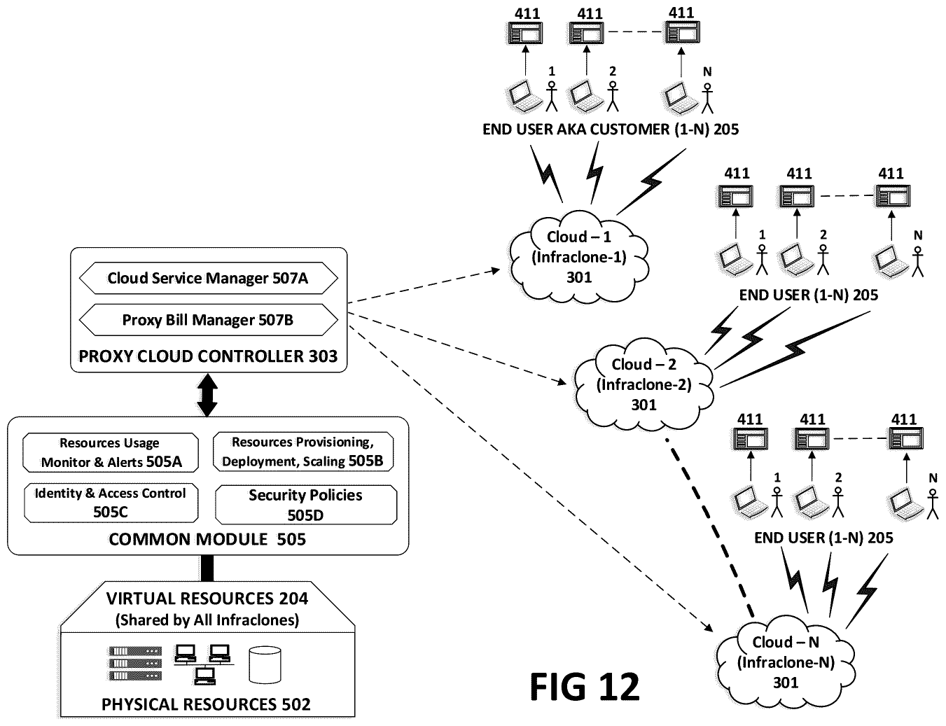

Proxy Cloud Controller 303 is a proxy to vCSP 409 and performs one or more functions generally carried out by the vCSPs 409. FIG. 12 shows Proxy Cloud Controller 303 communication diagram. For the purpose of explanation, the Proxy Cloud Controller 303 is shown with two sub-modules, the Cloud Service Manager 507A and Proxy Bill Manager 507B. Proxy cloud portal 411 shown separately for end users 205 for the purpose of explanation accepts the end users 205 cloud computing service requests. While a web-portal 411 is shown as the communication interface 411 between the end users 205 and Proxy Cloud Controller 303, the communication interface 411 may be made up of one or more interfaces including but not limited to direct site-to-site connections, remote access network connections; OSI layer 2 or layer 3 connections including VLAN, VXLAN, VPN; leased lines, etc., or a combination thereof.

The service offered by Proxy Cloud Controller 303 to end users 205 include but not limited to cloud computing services like infrastructure services, platform services, software application services, etc.; dynamic allocation, auto-scaling, upgrade or downgrade of computing virtual resources 204 and services being used by the end users 205; and so on. The end users 205 request for the services from the Proxy Cloud Portal 411 and once confirmed by the end user 205, the Proxy Cloud Controller 303 module processes and completes the requested task. The common module 505 assist Proxy Cloud Controller 303 to accomplish one or more tasks or a combination of tasks requested by the Proxy Cloud Controller 303 including creating, provisioning, deployment and scaling 505B of cloud services using custom or pre-defined template or without a template or by other means. The common module 505 also assists the Proxy Cloud Controller 303 in monitoring 505A of computing virtual resources 204 used by the end users 205 and providing alerts 505A to the end users 205 related to their computing virtual resources 204 usage and performance; managing the security polices 505D for end users 205 and their virtual resources 204, and managing the identity and access control 505C for the end users 205.

The Proxy Cloud Controller 303 receives the service request from the end user 205 through Proxy Cloud Portal 411. The Proxy Cloud Portal 411 may include a resource services request or update or scaling wizard that will walk through the end users 205 with default settings or targeted options to suit the end user 205 requirements. The services selected through the wizard could include new computing virtual resources 204 creation, scaling of virtual resources 204, deletion of virtual resources 204, and so on. Once the selections are made, the end user 205 will validate the selection and submits the request to Proxy Cloud Controller 303 through the Proxy Cloud Portal 411. The service input method may also involve clicking various buttons on the Proxy Cloud Portal 411, selecting item(s) from one or more dropdown boxes, or providing inputs through one or more wizards, methods used for requesting remote internet services, or a combination thereof. The portal 411 may provide access to open multiple windows or links to use the cloud computing services.

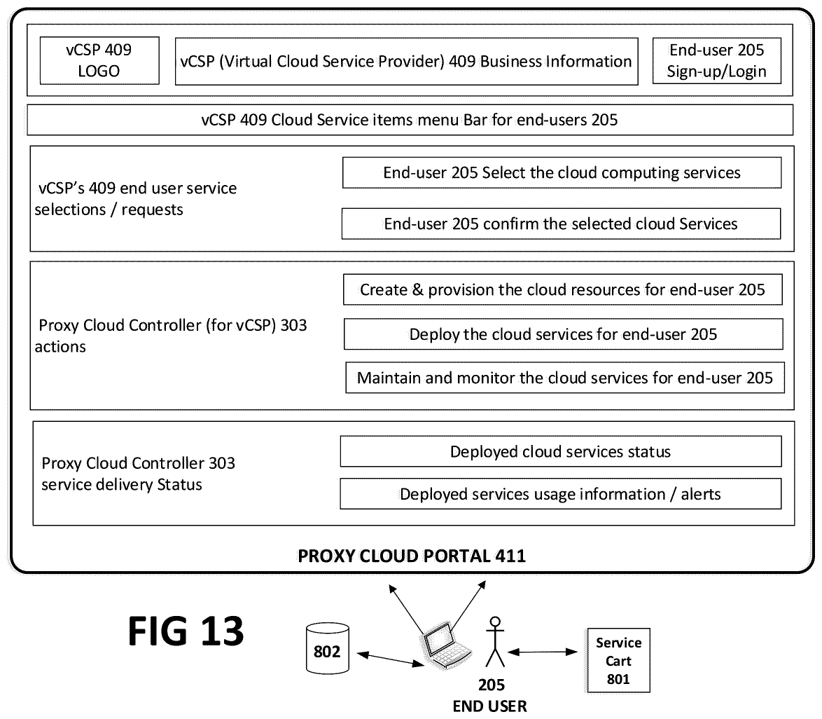

The Proxy Cloud Portal 411, expanded in FIG. 13, may provide for end users 205, account signup and login options, demo video links on the cloud and computing services offered, help and documentation on cloud computing services and offers, configuration and submittal of requests for deployment and/or scaling of computing virtual resources 204, SLA management of end user 205 services, various recommendations both static and dynamic according to end user 205 applicable services, a dashboard of services available and used by end users 205, real-time updates, graphs of service consumed; APIs for building services for deployment, monitoring, scaling, predictions, automation, capacity analysis, policy, and security services; template services, user targeted recommendations, an e-commerce shopping cart 801 for placing the selected clone 301 services for checkout and submission of selected services, options to update/delete the information stored in the cart 801 or cancel the selected services before checking out, monitoring or alert windows to draw end users 205 attention, and many more. The portal 411 may also include a browser cache or a datastore 802 for storing the data of unsigned users 205 or for temporary use that can be used for portal 411 configuration management, portal 411 services, namespace management, and/or other items; or other storage 204B media for storing the initial inputs that users 205 key-in before making a final click on the type of service that the user 205 like to request. Options may also be available for the end users 205 to create cloud service template(s) that may be used for different applications, reusing of virtual resources 204, creation of services for end users 205 internal and external use, etc. Proxy Cloud Controller 303 (FIG. 12), upon receiving a service request from end user 205, checks whether it is cloud services (virtual resources 204) related request, or billing and payment related service request for the virtual resources 204 consumed by the end user 205. Depending on the type of request, the Proxy Cloud Controller 303 transfers the control to Cloud Service Manager 507A or Proxy Bill Manager 507B. While for the purpose of clarity the Proxy Cloud Controller 303 shows only two sub modules (blocks) 507A-B, one for cloud services 507A, and the other for usage bill services 507B, blocks may be added, deleted, combined or arranged in any manner to achieve the desired results.

The Cloud Service Manager 507A, the module within the Proxy Cloud Controller 303, is responsible for creation and deployment of new computing virtual resources 204, and/or scaling of virtual resources 204 used by the end users 205 as and when needed or upon request by the end users 205. The Cloud Service Manager 507A analyzes the end user 205 cloud service request to verify if it is a new virtual resources 204 creation request; or a scaling, update, or delete request for an existing resources. If the request is for the new virtual resources 204 creation and the user 205 is signing up for the first time, then the Cloud Service Manager 507A provides the details of the services available, business requirements, SLA, payment, recommendations and other items for the end user 205 to verify and confirm, and Cloud Service Manager 507A receives the finalized cloud services request from the end user 205. Upon verifying and approving the SLA and the services requested by the end user 205 for the new cloud resources 204 creation, the Cloud Service Manager 507A creates and provisions the virtual resources 204 either from the available templates or from a newly created template or without the need of a template, and deploys the virtual resources 204 and informs the end user 205 that the virtual resources 204 have been created and are ready for use.

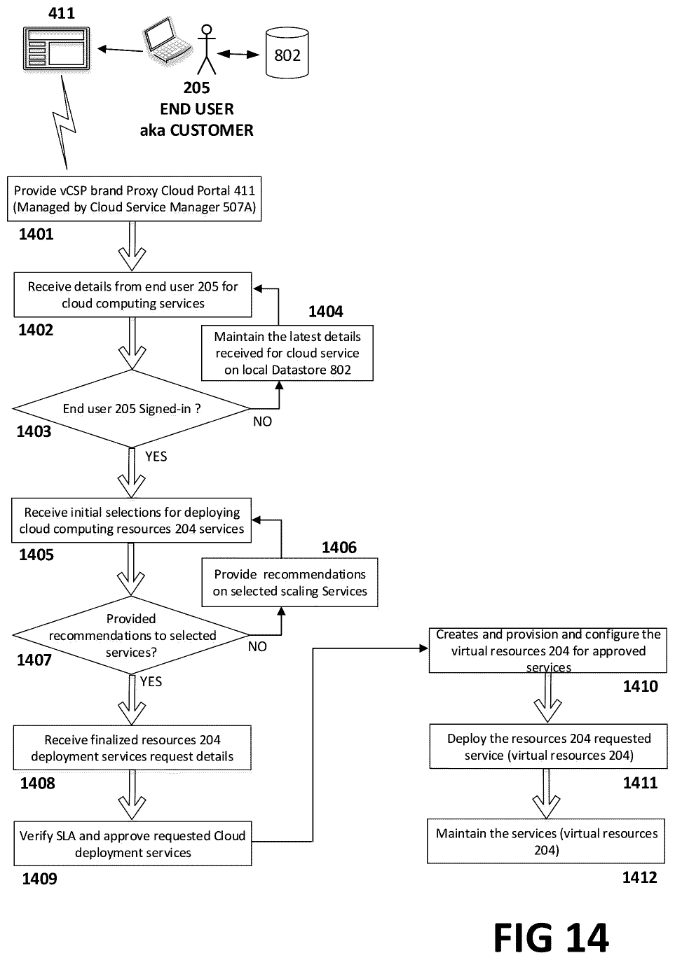

The process of end user 205 virtual resources 204 creation can be best explained with the help of a flowchart shown in FIG. 14. The Proxy Cloud Portal 411 is used for communication between end users 205 and Cloud Service Manager 507A. Consider a cloud virtual resources 204 end user (i.e., a potential or existing business, an individual, etc.) 205 who has not setup any account with the vCSP 409 visits the Proxy Cloud Portal 411 and checks the cloud computing services (BOX 1401) available for the end users 205. As an unsigned end-user 205 (BOX 1403) of the portal 411, the end user 205 might be interested in knowing the services, running the demo(s) or other things to understand how the cloud computing works or the services are consumed rather than actually signing up for the service that the end user 205 is not familiar with or unheard of. The end user 205 might decide to proceed with the selection of service components for availing the cloud services and as the end user 205 is not yet signed in (BOX 1403), the details the end user 205 provide for the requested services (BOX 1402) may be stored in a datastore/cache 802 (BOX 1404). When the vCSP 409 signup or sign-in (BOX 1403), the Cloud Service Manager 507A checks the end user's 205 datastore 802 (BOX 1404) and loads in the information and the datastore 802 (BOX 1404) gets updated as and when the end user 205 adds or updates the details for the requested services in the datastore/cache 802 (BOX 1404). When the initial selection of the services by the end user 205 is complete and submitted along with the end user 205 specific SLA, compliance and any other details (BOX 1405), the Cloud Service Manager 507A verifies the selected services and provides recommendations to selected services (BOX 1406-1407) that may be applicable for the end user 205 along with any additional requirements to meet the end user 205 compliance, SLA and other requirements. Upon going through the recommendations (BOX 1406-1407) and with any changes made to the end user 205 request details, the end user 205 submits the final request (BOX 1408) along with any additional details required for availing the cloud computing services. The Cloud Service Manager 507A verifies that the services request, the compliance, SLA and other details provided by the end user 205 are in order (BOX 1409), and creates and provisions the computing virtual resources 204 for the approved services (BOX 1410) and deploys (BOX 1411) the virtual resources 204 with the assistance of common module 505 owned by both Infraclone Controller 302 and Proxy Cloud Controller 303, and informs the end user 205 that the deployed virtual resources 204 are ready for use. The Proxy Cloud Controller 303 will start managing the deployed computing virtual services (resources) 204 for the attached vCSP 409 as a proxy to vCSP 409 (BOX 1412).

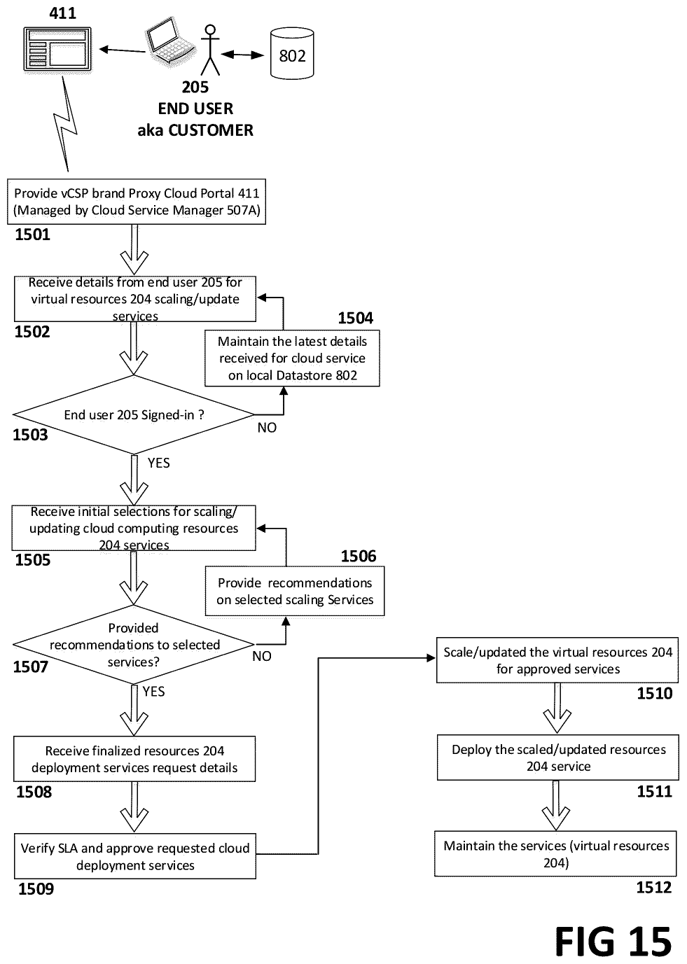

As and when needed, the end user 205 may need additional computing virtual resources 204, scale up or down the existing virtual resources 204, or discontinue virtual resources 204 being used. The Cloud Service Manager 507A; in addition to creating, provisioning, deploying, and maintaining the cloud virtual resources 204; performs these functions. The cloud virtual resources 204 scaling, upgrade or downgrade process may be best explained with the help of a flowchart shown in FIG. 15. Consider an end user 205 using cloud virtual resources 204 intend to use new or additional virtual resources 204, scale the virtual resources 204, or likes to remove the virtual resources 204 from existing use, or perform any other tasks that might need the Cloud Service Manager 507A support. The end user 205 might visit the portal 411 (BOX 1501) unsigned or signed (BOX 1503). An unsigned end user 205 (BOX 1503) may visit the portal 411 (BOX 1501) and check the additional, scaling or update services available for the end users 205. As an unsigned end user 205 of the Proxy Cloud Portal 411 (BOX 1503), the end user 205 might be interested in knowing new service offers or understanding how to scale, upgrade, downgrade or remove the virtual resources 204 from the current use; running the demo(s) or other things to understand how the new or additional virtual resources 204 creation, scaling and/or updates services might work without actually availing the services; and so on. The end user 205 might decide to proceed with the selection of service components for availing the services and as the end user 205 is not yet signed in (BOX 1503), the details the end user 205 provides for the requested services (BOX 1502) may be stored in a datastore/cache 802 (BOX 1504). When the end user 205 sign-in (BOX 1503), the Cloud Service Manager 507A checks the end user's 205 datastore 802 (BOX 1504) and loads in the information and the datastore 802 (BOX 1504). gets updated as and when the end user 205 adds or updates the details for the requested services in the datastore/cache 802 (BOX 1504). When the initial selection of the services by the end user 205 is complete and submitted along with the end user 205 specific SLA, compliance, and any other details (BOX 1505), the Cloud Service Manager 507A verifies the selected services and provides recommendations to selected services (BOX 1506-1507) that may be applicable for the end user 205 along with any additional requirements to meet the end user 205 SLA, compliance and other requirements. Upon going through the recommendations (BOX 1506-1507) and with any changes made to end user 205 service request details, the end user 205 submits the final request (BOX 1508) along with any additional details required for availing the update services. The Cloud Service Manager 507A verifies that the services request, the compliance, SLA and other details provided by the end user 205 are in order (BOX 1509), scales or updates virtual resources 204 (BOX 1510) and deploys the scaled or updated resources (BOX 1511) with the assistance of the common module 505 owned by both Infraclone Controller 302 and Proxy Cloud Controller 303. The Proxy Cloud Controller 303 will continue to maintain the end user 205 virtual resources 204 (BOX 1512) with updated services.

The Proxy Bill Manager 507B is another module within the Proxy Cloud Controller 303 (FIG. 12). While the Cloud Service Manager 507A is responsible for creating, deploying, scaling and maintaining the cloud virtual resources 204 through the end user 205 interface (Proxy Cloud Portal) 411, the Proxy Bill Manager 507B provides proxy or indirect billing services for the vCSP 409 in which the end users 205 bill management is handled by the Proxy Bill Manager 507B, not by the vCSP 409. Upon Proxy Cloud Controller 303 confirming that the service request from an end user 205 or the internal system generated request is related to billing, the Proxy Cloud Controller 303 transfers the control to Proxy Bill Manager 507B to serve the request. The Proxy Bill Manager 507B communicates with the resources usage monitor and alerts module 505A and performs the billing calculations for the virtual resources 204 consumed through clone 301, accesses vCSP 409 specific billing template to which the end user 205 belongs, populates the billing with current details and transmits the information that will be presented on Proxy cloud portal 411 or through a communication channel for end users 205 of clone 301 (vCSP 409) including in the form of downloadable files or for viewing online.

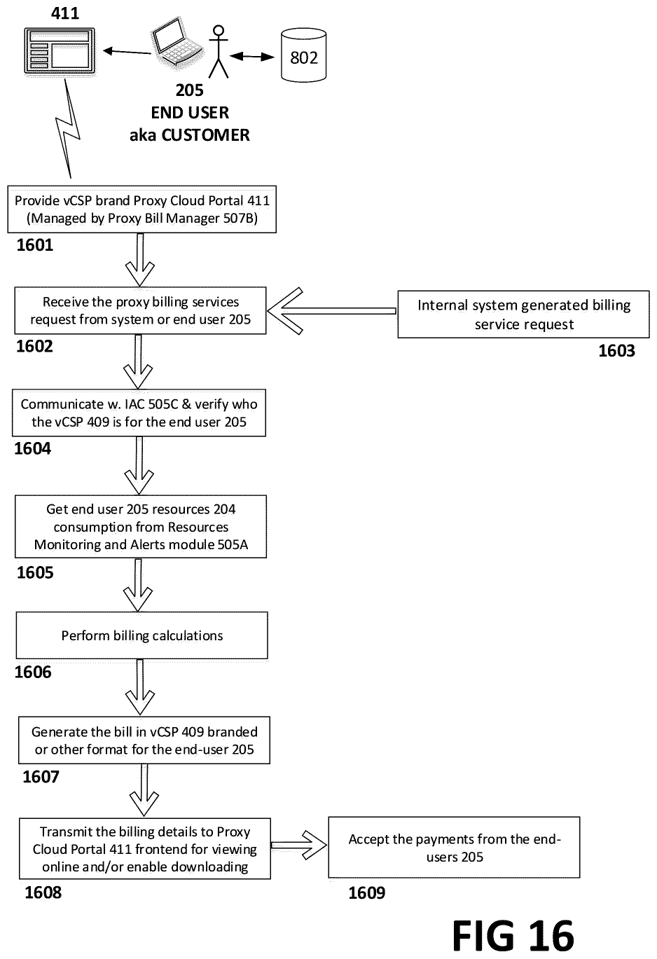

Whether it is an external request, end user 205 request or an internal system generated request, the generation and transmission of the bill to the end users 205 may be best understood with the help of a flow chart shown in FIG. 16. When the Proxy Bill Manager 507B receives a billing services request (BOX 1602) from the end-user 205 through Proxy Cloud Portal 411 (BOX 1601) or from internal system (BOX 1603), the Proxy Bill Manager 507B checks and verifies the vCSP 409 to whom the end user 205 is attached (BOX 1604) by communicating with the Identity and Access Control module 505C that keeps the users 205 isolated based on the access control set for each end user 205. Resources usage monitoring and alert module 505A (BOX 1605) keeps track of the virtual resources 204 consumed by the end users 205. The Proxy Bill Manager 507B gets the required information from the resources usage monitoring and alerts module 505A (BOX 1605) and performs the billing calculations for the resources 204 consumed for the requested or predetermined interval, or as the case may be. As the Proxy Bill Manager 507B has the information of the vCSP 409 to whom the end user 205 is attached, the Proxy Bill Manager 507B performs the billing calculations (BOX 1606) and populates the billing results, generates the bill in the vCSP 409 branded (optional) or other billing format (BOX 1607) as needed, and transmits to the bill the end user 205 for them to access online or download through clone's 301 Proxy Cloud Portal 411 or in any other form as the case may be (BOX 1608). In addition to transmittal of the bills to the end users 205, the Proxy Bill Manager 507B may also accept the payments made by the end users 205 (BOX 1609) through Proxy Cloud Portal 411 or other means, or perform other functions, including but not limited to technical support, on behalf of the vCSP 409 to which the end user 205 is attached.

### Proxy Cloud Controller Enable/Disable Switch

Until now, the disclosure focused on Proxy Cloud Controller 303 operation with an emphasis that the Proxy Cloud Controller 303 manages end users 205 computing services by default. However, at times, it may be required for one or more vCSPs 409 to directly manage their end users 205 and provide end user 205 computing services (virtual resources 204) through Infraclone(s) 301 they (vCSPs 409) own without the need of the default proxy cloud services provided by virtual infrastructure provider 500.

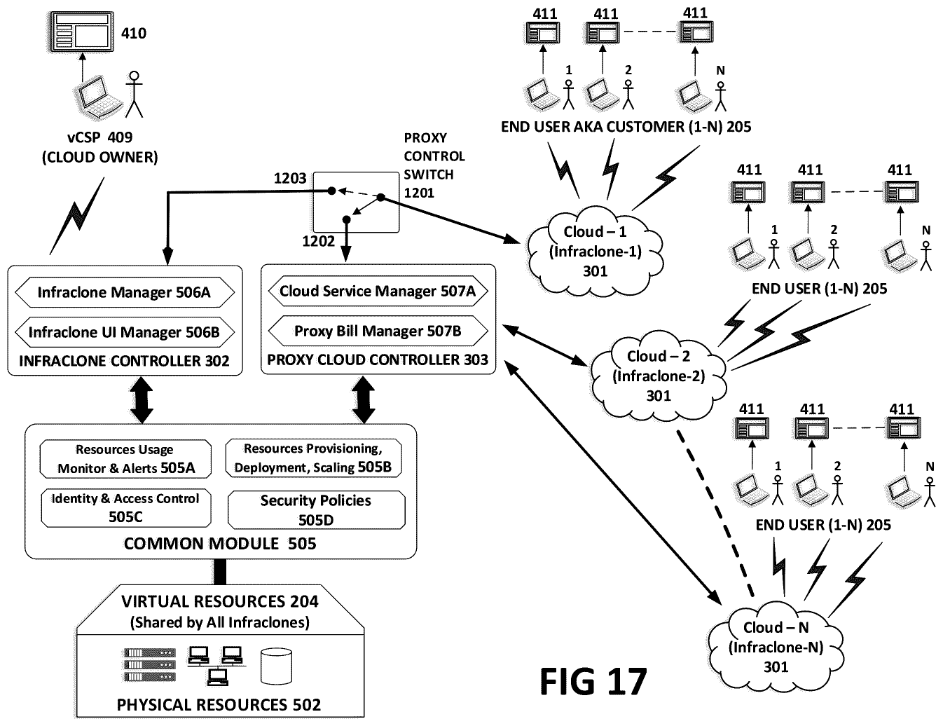

The Infraclone Controller 302 that is responsible for managing the Infraclone 301 user interface (Proxy Cloud Portal) 411, enables or disables the proxy cloud control service for the vCSP 409 by operating a proxy control switch 1201 (FIG. 17) that may be designed with software, hardware, firmware, middleware or any other methods, or a combination thereof. When proxy control switch 1201 is in one state 1202, the Proxy Cloud Controller 303 manages the Infraclone 301 end users 205 as a proxy to vCSP 409 and perform the functions of the vCSP 409. However, when proxy control switch 1201 is in any other state(s) 1203, the vCSP 409 directly manages its Infraclone 301 end users 205 and performs the functions of a cloud service provider 409, which is otherwise managed by the Proxy Cloud Controller 303.

### CONCLUSION

While aforesaid invention explains a method to create one or more Infraclones (infrastructure clones, virtual copies of physical cloud infrastructure, virtual cloud infrastructure or virtual clouds) from a physical infrastructure to provide cloud computing services, it should be understood that said method may be used to create public cloud, private cloud, hybrid cloud, community cloud, or any other cloud, or a combination thereof. The method and examples provided in this invention are not constrained so long the method or procedure results in creation of one more virtual copies of physical infrastructure, wherein each such created copy may be used as an independent cloud to provide cloud computing services like infrastructure services, platform services, software services, etc. Suitable changes, alterations, additions, deletions and substitutions may be made without departing from the fundamental theme of this invention.

### DRAWINGS

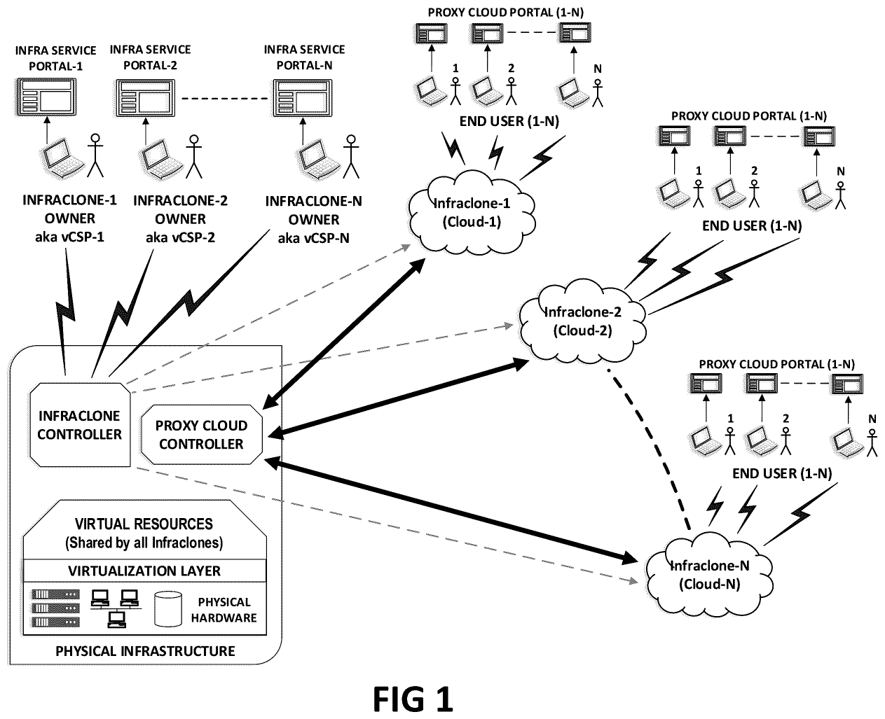

FIG. 1 to FIG. 17 attached

1. A method comprising:
a) At least one Infraclone Controller device receiving service request, from one or more cloud service providers (aka virtual cloud service providers), to provide one or more Infraclones (aka virtual copies of physical cloud infrastructure);
b) Analyzing and determining the services by said at least one Infraclone Controller device for said service request; and
c) Creating and deploying one or more said Infraclones by said at least one Infraclone Controller device for said service request.

2. The method of claim 1, further comprising at least one user interface, generally a portal, for communicating between said at least one Infraclone Controller device and said cloud service provider(s).

3. The method of claim 1, further comprising a means for monitoring and/or managing said deployed Infraclone(s) for said cloud service provider(s).

4. The method of claim 1, further comprising a means for scaling and/or updating said deployed Infraclone(s) based on said cloud service provider(s)′ requirements or based on analysis by said at least one Infraclone Controller device or some combination thereof.

5. The method of claim 1, wherein said deployed Infraclone(s) can be used as public cloud(s), private cloud(s), hybrid cloud(s), community cloud(s) or some combination of cloud(s) thereof.

6. A method comprising:
a) Receiving service request by at least one Infraclone service provider, from one or more cloud service providers (aka virtual cloud service providers), to provide one or more Infraclones (aka virtual copies of physical cloud infrastructure);
b) Analyzing and determining the services by said at least one Infraclone service provider for said service request; and
c) Creating and deploying Infraclone services by said at least one Infraclone service provider for said service request.

7. The method of claim 6, further comprising at least one user interface, generally a portal, for accepting said service request(s) and for delivering said Infraclone services.

8. The method of claim 6, further comprising monitoring and/or managing of said deployed Infraclone services for said cloud service provider(s).

9. The method of claim 6, further comprising scaling and/or updating of said deployed Infraclone services based on said cloud service provider(s)′ requirements or based analysis by said at least one Infraclone service provider or some combination thereof.

10. The method of claim 6, wherein said Infraclone services are availed by said cloud service provider(s) for providing public cloud services, private cloud services, hybrid cloud services, community cloud services or some combination of cloud services thereof.

11. A method comprising:
a) At least one Proxy Cloud Controller device, working as a proxy for one or more cloud service providers (aka virtual cloud service providers);
b) Said at least one Proxy Cloud Controller device receiving service request, from one or more customers (aka end users) of said cloud service provider(s), to provide cloud computing resources;
c) Analyzing and determining the services by said at least one Proxy Cloud Controller device for said service request; and
d) Creating and deploying said cloud computing resources, by said at least one Proxy Cloud Controller device, for said service request.

12. The method of claim 11, further comprising at least one user interface, generally a portal, for communicating between said at least one Proxy Cloud Controller device and said customers, between said at least one Proxy Cloud Controller device and said cloud service providers(s) or some combination thereof.

13. The method of claim 11, further comprising a means for monitoring and/or managing of said deployed computing resources for said customers.

14. The method of claim 11, further comprising a means for scaling and/or updating said deployed computing resources based on said customer(s)′ requirements or based on analysis by said at least one Proxy Cloud Controller device or some combinations thereof.

15. The method of claim 11, further comprising at least one Proxy Control Switch device, wherein when said at least one Proxy Control Switch device is in one of the states, said at least one Proxy Cloud Controller device manages said customers; and when said at least one Proxy Control Switch device is in another state(s), said cloud service provider(s) may manage said customers.

16. The method of claim 11, further comprising a means for providing proxy billing, proxy customer support, and/or other services that said cloud service provider(s) generally provide to their said customers.

17. A method of working as proxy cloud service provider(s) for at least one cloud service provider, and providing cloud computing services (aka resources) to customers (aka end users) of said at least one cloud service provider; comprising:
d) Receiving service request by said at least one proxy cloud service provider, from one or more said customers, to provide said cloud computing resources;
e) Analyzing and determining the services by said at least one proxy cloud service provider for said service request; and
f) Creating and deploying said cloud computing resources by said at least one proxy cloud service provider for said service request.

18. The method of claim 17, further comprising at least one user interface, generally a portal, for accepting said service request(s) and for delivering said cloud computing services.

19. The method of claim 17, further comprising monitoring and/or managing of said deployed cloud computing resources for said customers.

20. The method of claim 17, further comprising scaling and/or updating of said deployed cloud computing resources based on said customer's requirements or based on analysis by said at least one proxy cloud service provider or some combinations thereof.

21. The method of claim 17, further comprising of providing proxy billing services, proxy customer support services and/or other services that said at least one cloud service provider generally provides to its said customers.

22. A system comprising:
a. At least one physical cloud infrastructure comprising compute, storage, networking, and/or software components;
b. At least one virtualization means for abstracting virtual resources from said physical cloud infrastructure to derive one or more Infraclones (aka virtual copies of said physical cloud infrastructure) and cloud computing resources; and
c. At least one user interface, generally a portal; for receiving service requests from users of said Infraclone(s) and/or said cloud computing resources; and delivering the services to said users of said Infraclone(s) and/or said cloud computing resources.

23. The system of claim 22, further comprising at least one Infraclone Controller device for creating and deploying said Infraclone(s), wherein said deployed Infraclone(s) can be used as public cloud(s), private cloud(s), hybrid cloud(s), community cloud(s) or some combination of cloud(s) thereof for providing cloud computing services.

24. The system of claim 22, further comprising a means for monitoring and/or managing said deployed Infraclone(s).

25. The system of claim 22, further comprising a means for scaling and/or updating said deployed Infraclone(s).

26. The system of claim 22, further comprising at least one Proxy Cloud Controller device for working as a proxy for cloud service provider(s), who provide cloud computing services through said Infraclone(s), wherein said at least one Proxy Cloud Controller is used for creating and deploying said cloud computing resources for said cloud service provider's customers (aka end users) on behalf of said cloud service provider(s).

27. The system of claim 22, further comprising a means for scaling and/or updating said deployed cloud computing resources.

28. The method of claim 22, further comprising at least one Proxy Control Switch device, wherein when said at least one Proxy Control Switch device is in one of the states, said at least one Proxy Cloud Controller device manages said customers; and when said at least one Proxy Control Switch device is in another state(s), said cloud service provider(s) may manage said customers.

29. The method of claim 22, further comprising a means for providing proxy billing, proxy customer support, and/or other services that said cloud service provider(s) generally provide to their said customers.
